(19) United States
(12) Patent Application Publication
(10) Pub. No.: US 2016/0140143 A1
(43) Pub. Date: May 19, 2016

(54) SYSTEM AND METHOD FOR A GEOSPATIAL DATABASE

(71) Applicant: Exogenesis Corporation, Lafayette, CO (US)

(72) Inventors: Sean Michael Anklam, Lafayette, CO (US); John Beakes Tuthill, III, Lafayette, CO (US); Barnabas Sprague, Lafayette, CO (US)

(73) Assignee: Exogenesis Corporation, Lafayette, CO (US)

(21) Appl. No.: 14/942,285

(22) Filed: Nov. 16, 2015

Related U.S. Application Data
(60) Provisional application No. 62/079,919, filed on Nov. 14, 2014.

(51) Int. Cl. G06F 17/30

(52) U.S. Cl. CPC G06F 17/30241; G06F 17/30569; G06F 17/30424

(57) ABSTRACT

The present disclosure describes methods, systems, and program products for generating an enhanced database, such as a geospatial database, and for searching an enhanced database, such as a geospatial database. The disclosed methods, systems, and program products incorporate a process for assigning labels to objects, such as polygons, linestrings, and points, based on the relationship between such polygons, linestrings, and points.

### RELATED AND CO-PENDING APPLICATIONS

This application claims priority to co-pending U.S. provisional application entitled “Geospatial Database”, Ser. No. 62/079,919 filed 14 Nov. 2014, the entirety of which is hereby incorporated herein by reference.

### BACKGROUND

The expanding ability to sense, capture, and store an enormous multitude of data-intensive images, events, locations, etc., has resulted in the creation of databases containing vast amounts of data. The sheer size of these databases far outstrips the ability of state-of-the-art databases and search methodologies to efficiently and effectively handle the extraction of relevant data. Furthermore, most state-of-the-art search strategies often rely on the employment of cryptic, non-user friendly search strings which are not only cumbersome to use but result in the need to hire expensive data analysts and usually require a series of searches to reveal the sought-after data. Consequently, the cost and complexity of searching these mammoth databases severely limits the availability of the data. These issues are further exacerbated for geospatial data, which can be gathered in any number of ways, such as, but not limited to, satellite and airborne imagery using various filters to capture data/images in a diverse number of frequency bands (infrared, visible, ultraviolet, etc.) Additionally, geospatial data may, for example, include spatio-temporal data to track changes and events through time over a particular location.

Traditional relational database management systems (“RDBMS”), such as the ESRI (Environmental Systems Research Institute) format geodatabase and SQL (structured query language) database, have failed to support the growing demands of big geospatial data and other large databases. Relational database management systems are excellent for spatial databases, but they cannot efficiently or effectively handle “big data” (i.e., large amounts of data). Object databases are excellent for “big data”, but have no inherent spatial capabilities.

The proliferation of new sensors, growing use case scenarios, rapid temporal change, constant data updates, massive file sizes, and a multitude of new data formats have driven the need for a new type of database. While traditional object database management systems (“ODBMS”) are effective at addressing these and other problems confronting relational databases, they are not spatially enabled. One example of an open-source, object database management system, the Mongo Database, has absolutely no limits in respect to size, scale, architecture, cloud deployment, etc. Additionally, no one object, no matter how similar it might be to a second object, may overwrite the second object in the Mongo database system. However, the Mongo Database has no spatial ability and therefore cannot be effectively used for geospatial data and other similar uses.

Accordingly, there is a need for a novel, unique, and powerful database system that represents a union between the two above-mentioned types of database management systems and furthermore can intake a huge volume of data, geospatial and otherwise, assign and manage labels associated with that data, and effectively and efficiently search the massive amounts of data that is gathered and added to the database system.

### BRIEF DESCRIPTION OF THE DRAWINGS

FIG. 1 is a drawing representing a label inheritance method for vector data polygons according to an embodiment of the present subject matter.

FIG. 2 is a drawing representing a label inheritance method for vector data polygons and linestrings according to an embodiment of the present subject matter.

FIG. 3 is a drawing representing a label inheritance method for vector data polygons, linestrings, and points according to an embodiment of the present subject matter.

FIG. 4 is a flow chart for a method for generating an enhanced geospatial database according to an embodiment of the present subject matter.

FIG. 5 is a flow chart for further methods for generating an enhanced geospatial database according to additional embodiments of the present subject matter.

FIGS. 6A-6C represent a flow chart for an additional method for generating an enhanced geospatial database according to another embodiment of the present subject matter.

FIG. 7 is a flow chart for a method for searching an enhanced geospatial database according to an embodiment of the present subject matter.

FIG. 8 is a flow chart for further methods for searching an enhanced geospatial database according to additional embodiments of the present subject matter.

FIGS. 9A-9C represent a flow chart for an additional method for searching an enhanced geospatial database according to another embodiment of the present subject matter.

FIG. 10 is a functional block diagram for a system for generating and/or searching an enhanced geospatial database according to an embodiment of the present subject matter.

### DETAILED DESCRIPTION

The following description of the present subject matter is provided as an enabling teaching of the present subject matter and its best, currently-known embodiment. Those skilled in the art will recognize that many changes can be made to the embodiments described herein while still obtaining the beneficial results of the present subject matter. It will also be apparent that for some embodiments, some of the desired benefits of the present subject matter can be obtained by selecting some of the features of the present subject matter without utilizing other features. Accordingly, those skilled in the art will recognize that many modifications and adaptations of the present subject matter are possible and may even be desirable in certain circumstances and are part of the present subject matter. Thus, the following description is provided as illustrative of the principles of the present subject matter and not in limitation thereof and may include modification thereto and permutations thereof. While the following exemplary discussion of embodiments of the present subject matter may be directed towards or reference specific systems and/or methods for remote measurement and process control solutions, it is to be understood that the discussion is not intended to limit the scope of the present subject matter in any way and that the principles presented are equally applicable to other systems and/or methods for remote measurement and process control solutions.

Those skilled in the art will further appreciate that many modifications to the exemplary embodiments described herein are possible without departing from the spirit and scope of the present subject matter. Thus, the description is not intended and should not be construed to be limited to the examples given but should be granted the full breadth of protection afforded by the appended claims and equivalents thereto.

With reference to the figures where like elements have been given like numerical designations to facilitate an understanding of the present subject matter, various embodiments of systems, methods, and program products for generating and searching an enhanced geospatial database, and other similar databases, are described.

The novel database systems, methods, and program products described herein that are capable of handling and searching massive volumes of data, geospatial and otherwise, and assign and manage labels associated with that data, is sometimes referred to herein as the “Gaia” system.

At Gaia's core, objects are represented as independent physical persons, places, things, and events. Gaia is unstructured, it does not require the use of file naming conventions, hierarch, tables, pre-defined relationships, or spatial joins. Gaia is a “non-SQL” database and offers a simple unstructured search interface. Unlike relational databases, Gaia does not require revisioning when new information is added, which saves users countless hours and money. Gaia is cloud deployable and is designed to integrate seamlessly within cloud enterprises. Gaia imposes no limitation on scale, file size, or distribution. Gaia in completely agnostic, its fusion engines can ingest data from any platform, sensor, source, or format. Use case scenarios can be created on the fly using Gaia instead of the database being designed around a use case scenario. In an embodiment, for the first time, objects that are not traditionally geospatial, such as, but not limited to, videos, documents, libraries or signatures, and social media, are now ingested and fully integrated with traditional geospatial datasets within Gaia.

Gaia's open search can return geospatial datasets from any source as well as, for example, publications, documents, web pages, photos, videos, etc., related to the search; material signatures from Gaia's library of over 18,000 (currently) unique chemical signatures; can be used to subscribe to spatial and thematic real time updates from web services; can export to any spatially enabled database format, export to any projection, datum, and coordinate system, and support any use case imaginable.

The Gaia database and management system technology revolves around a unique system and method of hybridizing object oriented and relational database management systems.

In an embodiment, the Gaia solution utilizes GeoJSON (Java Script Object Notation) such that every time a dataset is imported, the Gaia system generates a GeoJSON object for it within the basic database that describes the object in terms of spatial reference, attributes, relationships, etc. All of the generated metadata is expressed as well-known-text tags (which may be plain language text) and key value pairs.

While the resulting Gaia database remains completely flat, which is ideal for “big data”, the automated generation of rich tags, key value pairs, and other metadata describing relationships and spatial reference creates, in an embodiment, a pseudo-hierarchy, which is also ideal for “big data”.

In an embodiment, the Gaia system further implements an elasticsearch algorithm that indexes all of the information and/or metadata. In this embodiment, the elasticsearch algorithm indexes all GeoJSON object tags, labels, and key value pairs. The elasticsearch algorithm enables spatially fuzzy, unstructured queries for searching the database. Thus, users of the Gaia database can initiate queries using plain language through, for example, an Exogen Rails application, and the Gaia database system will return the requested data. In an embodiment, the Exogen Rails application is a front-end application that may be programmed, for example, in Ruby on Rails for providing a user interface, data visualization, subscription management, and data acquisition management. The Gaia database system will also manage subscriptions and can offer data visualization. Due to the unique format and architecture of the Gaia database system, no matter how big the database gets, the query results will always be returned in an extremely fact, accurate, and relevant manner. The query language is also unstructured.

In an embodiment, the Gaia database system/software may also be installed on a massive server farm, such as, but not limited to, Digital Globes, and run a completely automated process of ingesting, indexing, and searching all of the data in the database. In an embodiment, the Gaia system can run training programs to generate and/or update and/or manage the tags, labels and key value pairs in the system.

As used herein, data in the following context is being used as a broad category for either raster or vector data. Raster data may typically be a representation of an image as a surface divided into a regular grid of cells (i.e., tessellated). Raster data is typically useful for storing data that varies continuously. Vector data may typically be a representation of an image using points, lines, and polygons. Vector data is typically useful for storing data that has discrete boundaries, e.g., country borders, rivers, land parcels, roads, etc.

Data/Label Process Flow

Data is first acquired. This can take several different forms including, but not limited to: via a persistent connection to a provider, constantly polling their collections for new information; via an in-house product; purchased and downloaded from the one or more public networks; delivered via a hard drive or other memory-based media.

Vector Data:

There are generally two categories of vector data used: Features and Events. Features are usually something physical like a road, a building, a lake, an ecological region, a mineral deposit, etc. Feature data typically, but not always, has a spatial component only, i.e., is not time constrained. Events are generally things that happen (i.e., an occurrence) like tornadoes, floods, etc. Event data typically has a time constraint.

There may be some overlap between what constitutes a Feature and what constitutes an Event. This overlap typically has to do with, for example, the one or more type of sensor used, the wavelength on which a particular sensor operates, the time frame for the data collection and/or analysis, how much movement the object undergoes during a selected time frame, etc. For example, a first glacier may be considered a Feature if it does not move appreciably during a relevant data collection and/or analysis time frame. A second glacier may move appreciably during this same relevant data collection and/or analysis time frame and therefore may be considered an Event.

In particular embodiments, for both Features and Events:

1. The acquired data may be typically converted to json (JavaScript Object Notation) from whatever format it was acquired. The data may then be decomposed from a collection of Features or Events into individual objects, i.e., the data is broken into individual units (a “unit” of data may vary depending on the type of data in question) which are then processed. The original acquired data may be retained for later reference.

2. Each Feature (or Event) object may be assigned key values (attribute:value pairs or key:value pairs) and labels which may be both programmatically arrived at and/or extracted directly from existing data encoded in the original vector data.

3. Each key:value pair may be calculated, for example, quantitatively from existing Feature data, or by look up. Non-limiting examples include: height:10, area:500, length:100, date:2014-12-10-0-0-0, etc.

4. Labels may be extracted from existing information in the original vector data and the labels must have meaning without additional context (i.e., the labels typically must be understandable to a user without the need to rely on additional information for understanding). As a non-limiting example, if the original format is in ESRI shapefile format, the labels are extracted from the attributes. Label extraction typically depends on criteria such as, but not limited to: labels being proper nouns or nouns; and labels having meaning without requiring additional context. A label may be suggested based on that particular label's prior selection as a label and/or one or more linguistic characteristics of that particular label. Label extraction typically is semi-automatic, but may converge to becoming wholly automatic as more information is ingested into the system. Examples of labels include, but are not limited to: Lake Erie, riot, U.S. Embassy, Salton Sea, Boreal Tundra, etc.

5. Features and Events both inherit labels.

6. Features propagate their own labels based on their spatial relationships with existing Features. This propagation is governed by a collection of rules, as discussed below. Features inherit and propagate labels to other Features and also to Events.

7. Events do not typically propagate labels to any other vector objects within the system. However, Events may inherit labels from another Feature based on the spatial relationship between the Event and the Feature.

Embodiments for Vector Inherency Rules

Within the Gaia system the geojson primitives may typically be used for representing vector data (both Features and Events). Each object can typically be any of the following spatial data types: Polygon, LineString, Point, MultiLineString, MultiPoint, MultiPolygon, or a geometry collection. Polygons are typically associated with objects that have area. Strings are typically associated with objects that are generally linear. Points are typically associated with objects that are at a particular, relatively small and specific, location.

For MultiLineStrings, MultiPoints, MultiPolygons, and geometry collection Features, these are typically further decomposed into Polygon, LineString, and Point primitives.

In certain embodiments, a generalized label inheritance process then follows, where, as non-limiting examples:

1. Polygon A inherits from all polygons that Polygon A is a strict subset of. For example, if Polygon A is a subset with respect to Polygon B (or, to put it another way, Polygon B is a superset with respect to Polygon A), then Polygon A inherits all of Polygon B's labels. However, considering the same relationship between Polygon A and Polygon B, Polygon B does not inherit any of Polygon A's labels. In other words, for the polygon/polygon situation, labels only flow “downhill” from superset to subset.

Example: Polygon “Egypt” will inherit labels from Polygon “Africa” since Polygon “Egypt” is wholly within Polygon “Africa”. But, Polygon “Egypt” will not inherit labels from Polygon “Sudan” since Polygon “Egypt” is not wholly within Polygon “Sudan”.

2. LineString A inherits from all polygons that LineString A is a strict subset of. For example, if LineString A is a subset with respect to Polygon A (i.e., Polygon A is a superset with respect to LineString A), then LineString A inherits all of Polygon A's labels. LineString A cannot be a superset with respect to Polygon A, therefore Polygon A will not inherit any labels from LineString A.

Example: LineString “Nile River” will inherit all the labels from Polygon “Africa” since LineString “Nile River” is wholly within Polygon “Africa”. But, LineString “Nile River” will not inherit labels from Polygon “Egypt” since LineString “Nile River” is not wholly within Polygon “Egypt”.

3. LineString A does not inherit from any other LineString. LineStrings do not inherit labels from other LineStrings regardless of whether the two LineStrings intersect or not.

Example: LineString “Main Street” will not inherit any labels from LineString “1^{st} Avenue” even though LineString “Main Street” and LineString “1^{st} Avenue” intersect.

4. Point A inherits from all LineStrings and from all Polygons that Point A intersects with. For example, Point A will inherit labels from Polygon A if Point A intersects Polygon A. Point A will inherit labels from LineString A if Point A intersects LineString A. Point A does not inherit any labels from Point B unless Point A and Point B are coincident.

Example: Point “Town Hall” will inherit labels from LineString “Main Street” if Point “Town Hall” is located on (or borders on) LineString “Main Street”. Point “Town Hall” will inherit labels from Polygon “Anytown” if Point “Town Hall” is located within (or borders on) Polygon “Anytown”.

Raster Data:

Raster data may be represented as a polygon with a pointer to the actual binary data or to the binary data's location on a provider's system. Raster data typically is associated with measurement information, e.g., earth observation data, digital aerial photographs, satellite imagery (in any wavelength), digital pictures, scanned maps, temperature, elevation, etc.

Embodiments for Raster Inherency Rules

In certain embodiments, a generalized label inheritance process then follows, where, as non-limiting examples:

1. Raster data inherits from all Features that it intersects with. This includes all polygons, linestrings, and points. For example, Raster A intersects with, and therefore inherits labels from Polygon A, LineString A, and Point A.

Example: Raster A is elevation data at a Point A which is on LineString A which is within Polygon A. Therefore, Raster A will inherit labels from each of Point A, LineString A, and Polygon A.

2. Raster data inherits from all Events that intersect temporally and spatially. This includes all polygons, linestrings, and points. For example, Raster A intersects with (in both time and space) and therefore inherits labels from Polygon A, LineString A, and Point A.

Example: Raster A is elevation data at time “t” at a Point A (which is on LineString A which is within Polygon A). Event A occurs at Point A at time “t”. Therefore, Raster A inherits labels from Event A.

After completing the inherency process for both vector data and raster data, the database includes a collection of natural language descriptors associated with various space-based and earth-based data sets, for example, which can be explored via natural language queries through, for example, a captive web portal.

An embodiment of a full life cycle of an exemplary, non-limiting, dataset in pseudo code is presented below. An important feature of the rules above is that “cascading inherency” is avoided which would otherwise lead to Features and/or Events being associated with labels that have no bearing on that particular Feature and/or Event and, in the limit, may result in each Feature and/or Event being associated with every label.

process(raw geospatial data):

if raw geospatial data is vector:

for each feature in vector:

if feature is polygon:

get all polygons in main database that polygon is a
subset of:

update labels with set of new labels from superset
polygons

get all polygons in main database that polygon is a
superset of:

update subset polygon labels with set of new
labels

if feature is linestring:

get all polygons in database that linestring is a subset
of:

update linestring labels with set of new labels
from superset

get all points that intersect with linestring:

update points with set of new labels

if feature is point:

get all labels from all features that point intersects
with.

update points with set of new labels

if raw geospatial data is raster:

find all features that raster intersects with:

update raster labels with set of new labels

find all events that raster intersects with:

update raster labels with set of new labels

In an embodiment, an additional feature/capability includes persistently polling the Gaia system to find raster data of certain labels to build training sets for automatic classification. For instance, when there exist N many rasters with label L, all rasters with label L will be combined into a training set for the automatic classification of untagged raster of interest using existing algorithms.

In another embodiment, the index created from all the labels in the Gaia system is query-able with “natural language” as well as by spatial boundaries or with combinations of both.

In a further embodiment, labels associated with a particular object are handled as a group by the system but each elemental label in the group is accessible individually (to facilitate individual searching by label). Additionally, the processing of labels is kept track of through time (e.g., a “family tree” of labels is formed and retained).

The resulting system/database/methodology is useful in assisting with the data discovery of geospatial data, or similar “big data”, without having inherent knowledge of the details of the underlying data. For example, the user will not need to know what particular combination of or type of sensor data is required to complete their query. Rather, the user will simply need to query the database with a “natural language” query, such as: “flood damage” along “Green River” in “1986”. Thus, the accessibility of the voluminous amount of geospatial data is greatly enhanced, lowering the cost of obtaining geospatial data as well as drastically reducing the amount of time required to obtain the requested information from the overall geospatial database.

The Gaia system can be set up to continuously and/or periodically and/or upon command obtain data (in whatever format) from disparate data providers for insertion and assimilation into the Gaia system. Data layers may be fused together.

In some embodiments, unique attributes of the Gaia system may include one or more of, but are not limited to: labeling and processing of incoming geospatial data; continuous feedback loop between labeling and processing functionality and the data and index functionalities; and each piece of data (and/or object) may be associated with a unique value or number (e.g., a “serial number”) which may be, for example, 512 characters in length.

In other embodiments, capabilities of the Gaia search engine may include one or more of, but are not limited to: real-time alerting of a user when predefined conditions are met (through use of machine learning of labels); real-time reporting of predefined occurrences; use of predictive capabilities; auto-population of additional labels (example: Feature having the label “building” may be auto-populated with additional labels such as “height”, “use”, “area”, etc.); and labels can be hierarchical and have multiple levels (in an embodiment, there may be 4 or 5 levels of tags).

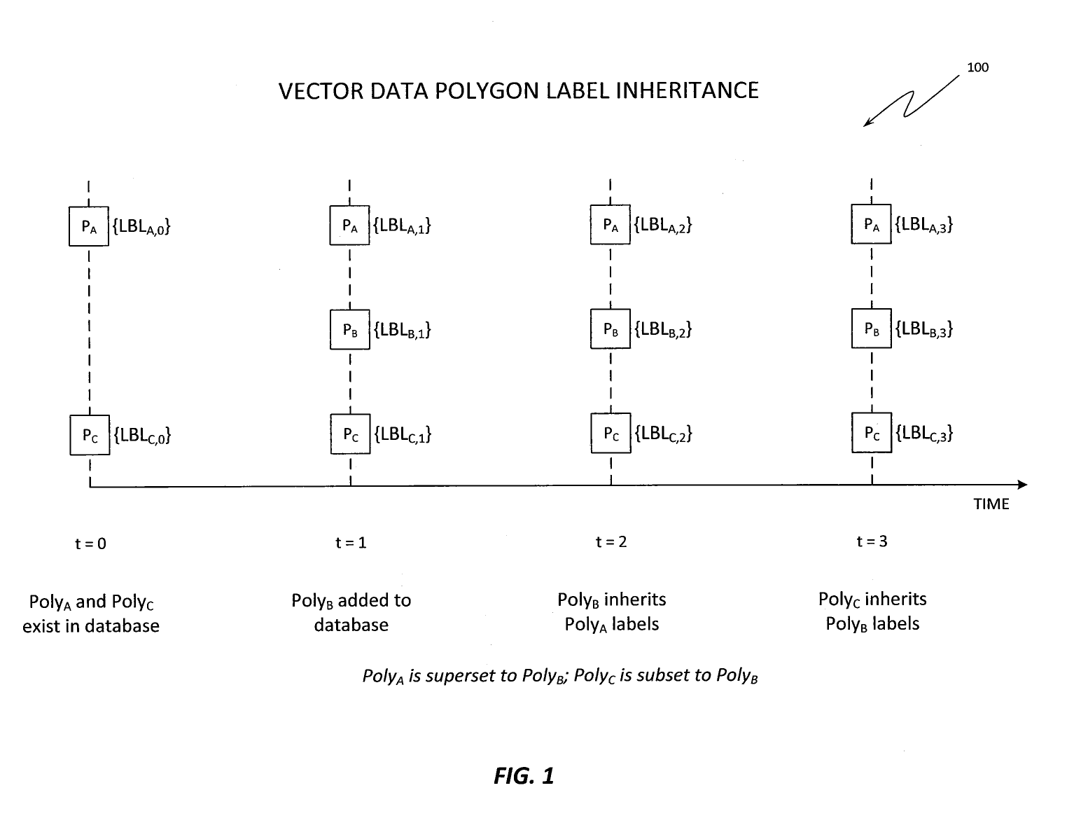

With attention drawn to FIG. 1, a drawing 100 is presented representing an exemplary, non-limiting, label inheritance method for vector data polygons according to an embodiment of the present subject matter. It shall be understood by those of skill in the art that the process depicted in FIG. 1 represents just one possibility of a label inheritance methodology for vector data polygons and that the concepts taught therein are extendable to other polygon label inheritance scenarios.

With time along the x-axis, FIG. 1 depicts a vector data polygon label inheritance process from time t=0 to time t=3. At time t=0, Polygon A (“Poly_{A}”, represented as block P_{A}) and Polygon C (“Poly_{C}”, represented as block P_{C}) exist in a database, such as the Gaia database described above. Throughout the process shown, Polygon A is associated with a set of labels {LBL_{A,t}} such that at t=0, Polygon A is associated with the set of labels {LBL_{A,0}}. Likewise, Polygon C is associated with a set of labels {LBL_{C,t}} such that at t=0, Polygon C is associated with the set of labels {LBL_{C,0}}. In an embodiment, Polygon A is a superset of Polygon C, therefore, as discussed above, Polygon C will have inherited (previous to time t=0, e.g., t=−1) labels associated with Polygon A.

At time t=1, Polygon B (“Poly_{B}”, represented as block P_{B}) is added to the database. As shown in FIG. 1, Polygon A is a superset to Polygon B and Polygon C is a subset to Polygon B. Polygon B is associated with the set of labels {LBL_{B,1}}. The set of labels associated with Polygon A has not changed from t=0 to t=1, so Polygon A is now associated with the set of labels {LBL_{A,1}} where {LBL_{A,1}} ={LBL_{A,0}}. Likewise, Polygon C is now associated with the set of labels {LBL_{C,1}} where {LBL_{C,1}}={LBL_{C,0}}.

At time t=2, Polygon B inherits labels from Polygon A (which, as stated above, is a superset to Polygon B) as follows:

{LBL_{B,2}}={LBL_{A,2}}+Δ{LBL_{B,1}}

where:

{LBL_{B,2}}=the set of labels for Polygon B at t=2

{LBL_{A,2}}=the set of labels for Polygon A at t=2

Δ{LBL_{B,1}}=the set of labels that are unique to Polygon B
at t=1 with respect to the labels for Polygon A
at t=1, which can be written as:

Δ{LBL_{B,1}}={LBL_{B,1}}−{LBL_{A,1}}

Thus, {LBL_{B,2}} represents the set of labels for Polygon B at t=2.

The set of labels associated with Polygon A has not changed from t=1 to t=2, so Polygon A is now associated with the set of labels {LBL_{A,2}} where {LBL_{A,2}}={LBL_{A,1}}. Likewise, the set of labels associated with Polygon C has not changed from t=1 to t=2, so Polygon C is now associated with the set of labels {LBL_{C,2}} where {LBL_{C,2}}={LBL_{C,1}}.

At time t=3, Polygon C inherits labels from Polygon B (which, as stated above, Polygon C is a subset to Polygon B) as follows:

{LBL_{C,3}}={LBL_{B,3}}+Δ{LBL_{C,2}}

where:

{LBL_{C,3}}=the set of labels for Polygon C at t=3

{LBL_{B,3}}=the set of labels for Polygon B at t=3

Δ{LBL_{C,2}}=the set of labels that are unique to Polygon C
at t=2 with respect to the labels for Polygon B
at t=2, which can be written as:

Δ{LBL_{C,2}}={LBL_{C,2}}−{LBL_{B,2}}

Thus, {LBL_{C,3}} represents the set of labels for Polygon C at t=3.

The set of labels associated with Polygon A has not changed from t=2 to t=3, so Polygon A is now associated with the set of labels {LBL_{A,3}} where {LBL_{A,3}}={LBL_{A,2}}. Likewise, the set of labels associated with Polygon B has not changed from t=2 to t=3, so Polygon B is now associated with the set of labels {LBL_{B,3}} where {LBL_{B,3}}={LBL_{B,2}}.

If Polygon C was not a subset to Polygon B, Polygon C would not inherit any labels from Polygon B.

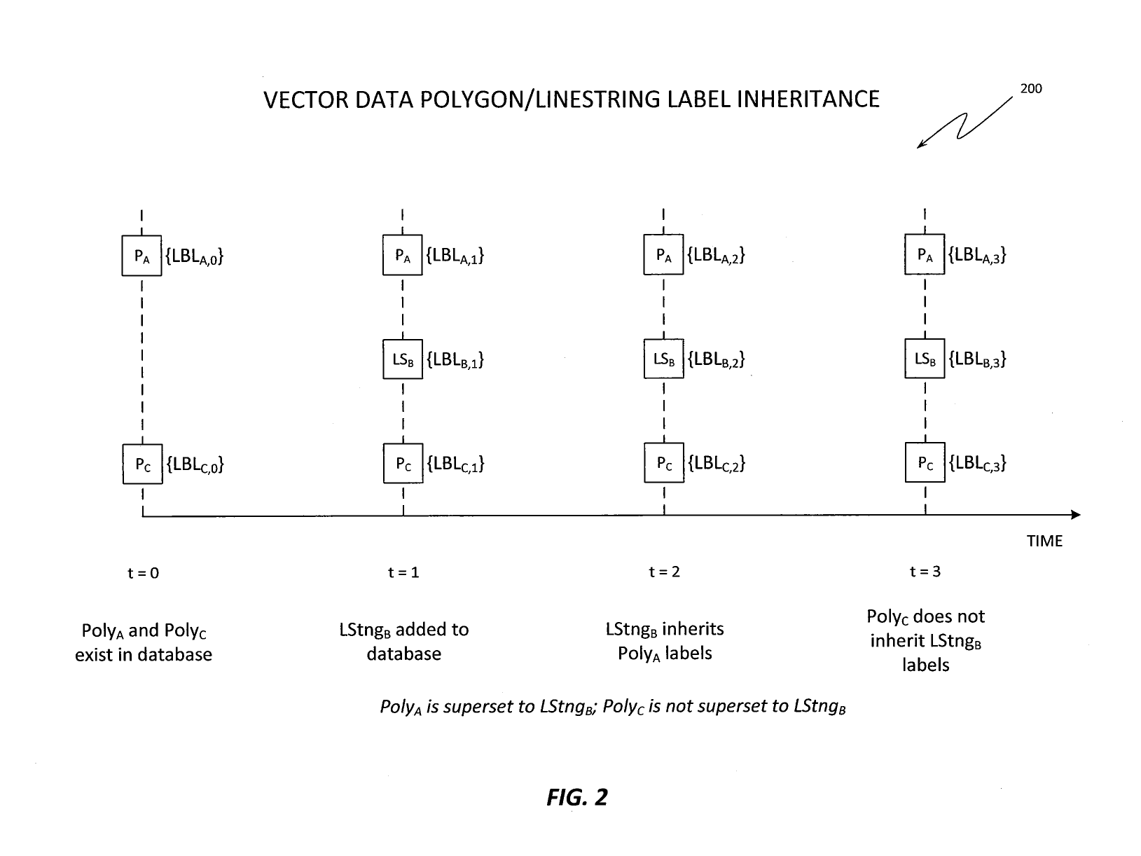

Now turning to FIG. 2, a drawing 200 is presented representing an exemplary, non-limiting, label inheritance method for vector data polygons and linestrings according to an embodiment of the present subject matter. It shall be understood by those of skill in the art that the process depicted in FIG. 2 represents just one possibility of a label inheritance methodology for vector data polygons and linestrings and that the concepts taught therein are extendable to other polygon and linestring label inheritance scenarios.

With time along the x-axis, FIG. 2 depicts a vector data polygon/linestring label inheritance process from time t=0 to time t=3. At time t=0, Polygon A (“Poly_{A}”, represented as block P_{A}) and Polygon C (“Poly_{C}”, represented as block P_{C}) exist in a database, such as the Gaia database described above. Throughout the process shown, Polygon A is associated with a set of labels {LBL_{A,t}} such that at t=0, Polygon A is associated with the set of labels {LBL_{A,0}}. Likewise, Polygon C is associated with a set of labels {LBL_{C,t}} such that at t=0, Polygon C is associated with the set of labels {LBL_{C,0}}. In an embodiment, Polygon A is a superset of Polygon C, therefore, as discussed above, Polygon C will have inherited (previous to time t=0, e.g., t=−1) labels associated with Polygon A.

At time t=1, LineString B (“LStng_{B}”, represented as block LS_{B}) is added to the database. As shown in FIG. 2, Polygon A is a superset to LineString B but Polygon C is not a superset or subset to LineString B. LineString B is associated with the set of labels {LBL_{B,1}}. The set of labels associated with Polygon A has not changed from t=0 to t=1, so Polygon A is now associated with the set of labels {LBL_{A,1}} where {LBL_{A,1}}={LBL_{A,0}}. Likewise, Polygon C is now associated with the set of labels {LBL_{C,1}} where {LBL_{C,1}}={LBL_{C,0}}.

At time t=2, LineString B inherits labels from Polygon A (which, as stated above, is a superset to LineString B) as follows:

{LBL_{B,2}}={LBL_{A,2}}+Δ{LBL_{B,1}}

where:

{LBL_{B,2}}=the set of labels for LineString B at t=2

{LBL_{A,2}}=the set of labels for Polygon A at t=2

Δ{LBL_{B,1}}=the set of labels that are unique to LineString B
at t=1 with respect to the labels for Polygon A
at t=1, which can be written as:

Δ{LBL_{B,1}}={LBL_{B,1}}−{LBL_{A,1}}

Thus, {LBL_{B,2}} represents the set of labels for LineString B at t=2.

The set of labels associated with Polygon A has not changed from t=1 to t=2, so Polygon A is now associated with the set of labels {LBL_{A,2}} where {LBL_{A,2}}={LBL_{A,1}}. Likewise, the set of labels associated with Polygon C has not changed from t=1 to t=2, so Polygon C is now associated with the set of labels {LBL_{C,2}} where {LBL_{C,2}}={LBL_{C,1}}.

At time t=3, Polygon C does not inherit labels from LineString B (which, as stated above, Polygon C is not a superset or subset to LineString B). Therefore, the labels associated with Polygon A, LineString B, and Polygon C have not changed from t=2 to t=3, so Polygon A is now associated with the set of labels {LBL_{A,3}} where {LBL_{A,3}}={LBL_{A,2}}, LineString B is now associated with the set of labels {LBL_{B,3}} where {LBL_{B,3}}={LBL_{B,2}}, and Polygon C is now associated with the set of labels {LBL_{C,3}} where {LBL_{C,3}}={LBL_{C,2}}.

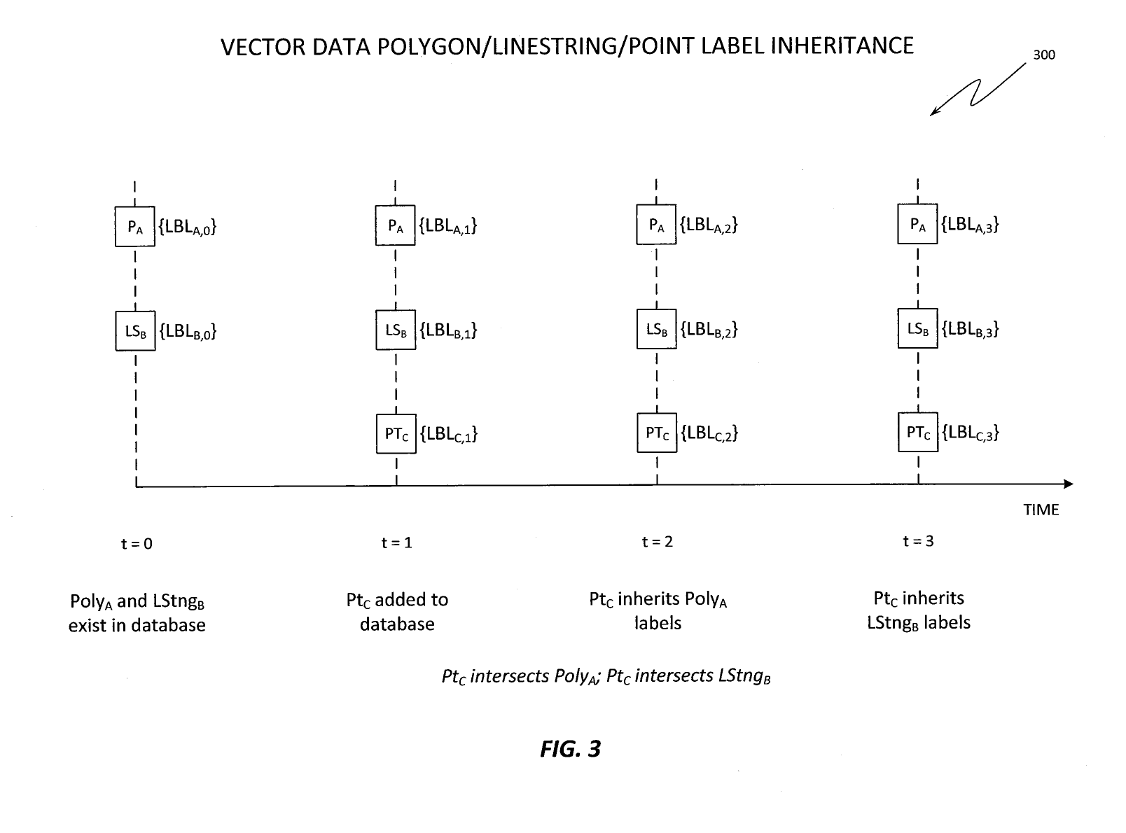

FIG. 3 illustrates a drawing 300 representing an exemplary, non-limiting, label inheritance method for vector data polygons, linestrings, and points according to an embodiment of the present subject matter. It shall be understood by those of skill in the art that the process depicted in FIG. 3 represents just one possibility of a label inheritance methodology for vector data polygons, linestrings, and points and that the concepts taught therein are extendable to other polygon, linestring and point label inheritance scenarios.

With time along the x-axis, FIG. 3 depicts a vector data polygon/linestring/point label inheritance process from time t=0 to time t=3. At time t=0, Polygon A (“Poly_{A}”, represented as block P_{A}) and LineString B (“LStng_{B}”, represented as block LS_{B}) exist in a database, such as the Gaia database described above. Throughout the process shown, Polygon A is associated with a set of labels {LBL_{A,t}} such that at t=0, Polygon A is associated with the set of labels {LBL_{A,0}}. Likewise, LineString B is associated with a set of labels {LBL_{B,t}} such that at t=0, LineString B is associated with the set of labels {LBL_{B,0}}. In an embodiment, Polygon A is a superset of LineString B, therefore, as discussed above, LineString B will have inherited (previous to time t=0, e.g., t=−1) labels associated with Polygon A.

At time t=1, Point C (“Pt_{C}”, represented as block PT_{C}) is added to the database. As shown in FIG. 3, Point C intersects Polygon A and therefore Polygon A is a superset to Point C. Point C also intersects LineString B and therefore LineString B is a superset to Point C. Point C is associated with the set of labels {LBL_{C,1}}. The set of labels associated with Polygon A has not changed from t=0 to t=1, so Polygon A is now associated with the set of labels {LBL_{A,1}} where {LBL_{A,1}}={LBL_{A,0}}. Likewise, LineString B is now associated with the set of labels {LBL_{B,1}} where {LBL_{B,1}}={LBL_{B,0}}.

At time t=2, Point C inherits labels from Polygon A (which, as stated above, is a superset to Point C) as follows:

{LBL_{C,2}}={LBL_{A,2}}+Δ{LBL_{C,1}}

where:

{LBL_{C,2}}=the set of labels for Point C at t=2

{LBL_{A,2}}=the set of labels for Polygon A at t=2

Δ{LBL_{C,1}}=the set of labels that are unique to Point C
at t=1 with respect to the labels for Polygon A
at t=1, which can be written as:

Δ{LBL_{C,1}}={LBL_{C,1}}−{LBL_{A,1}}

Thus, {LBL_{C,2}} represents the set of labels for Point C at t=2.

The set of labels associated with Polygon A has not changed from t=1 to t=2, so Polygon A is now associated with the set of labels {LBL_{A,2}} where {LBL_{A,2}}={LBL_{A,1}}. Likewise, the set of labels associated with LineString B has not changed from t=1 to t=2, so LineString B is now associated with the set of labels {LBL_{B,2}} where {LBL_{B,2}}={LBL_{B,1}}.

At time t=3, Point C inherits labels from LineString B (which, as stated above, Point C is a subset to LineString B) as follows:

{LBL_{C,3}}={LBL_{B,3}}+Δ{LBL_{C,2}}

where:

{LBL_{C,3}}=the set of labels for Point C at t=3

{LBL_{B,3}}=the set of labels for LineString B at t=3

Δ{LBL_{C,2}}=the set of labels that are unique to Point C
at t=2 with respect to the labels for LineString B
at t=2, which can be written as:

Δ{LBL_{C,2}}={LBL_{C,2}}−{LBL_{B,2}}

Thus, {LBL_{C,3}} represents the set of labels for Point C at t=3.

The set of labels associated with Polygon A has not changed from t=2 to t=3, so Polygon A is now associated with the set of labels {LBL_{A,3}} where {LBL_{A,3}}={LBL_{A,2}}. Likewise, the set of labels associated with LineString B has not changed from t=2 to t=3, so LineString B is now associated with the set of labels {LBL_{B,3}} where {LBL_{B,3}}={LBL_{B,2}}.

If Point C was not a subset to LineString B, Point C would not inherit any labels from LineString B.

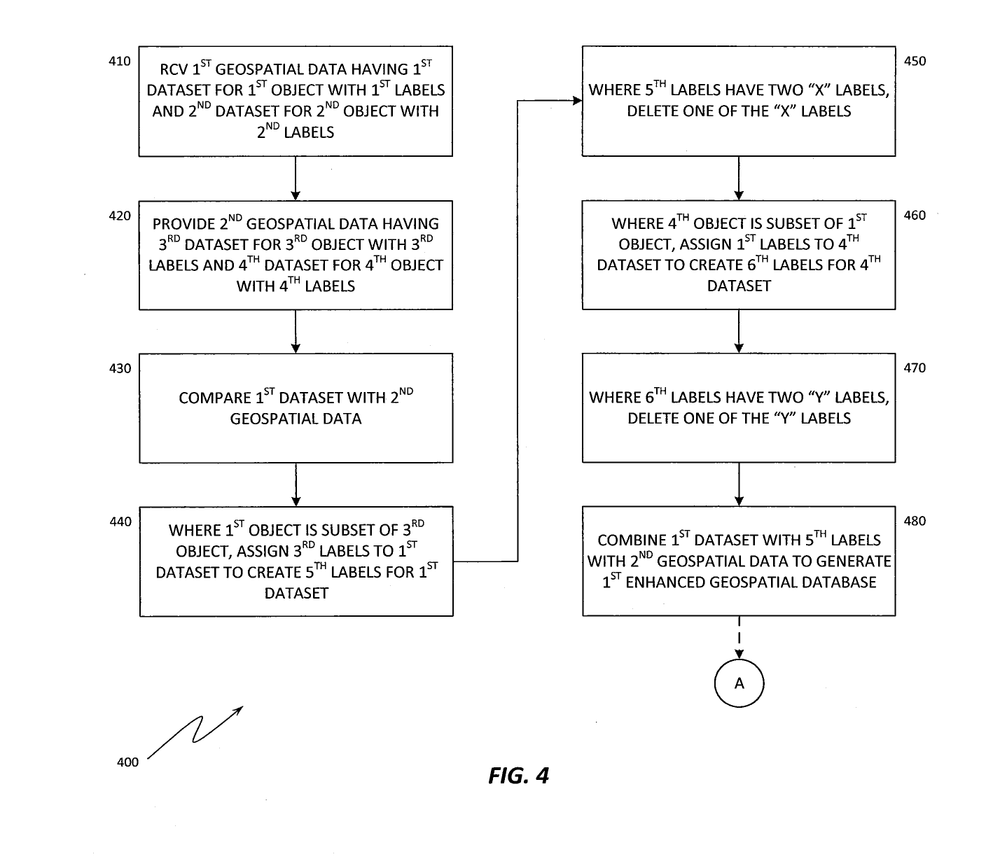

Considering FIG. 4, a flow chart 400 is presented for a method for generating an enhanced geospatial database according to an embodiment of the present subject matter.

At block 410, a first geospatial data is received where the first geospatial data comprises a first dataset having a first set of labels and a second dataset having a second set of labels, and where the first dataset represents a first object and the second dataset represents a second object.

At block 420, a database of second geospatial data is provided where the second geospatial data comprises a third dataset having a third set of labels and a fourth dataset having a fourth set of labels, and where the third dataset represents a third object and the fourth dataset represents a fourth object.

At block 430, the first dataset is compared with the second geospatial data.

At block 440, for the condition where the first object is a subset of the third object, the third set of labels is assigned to the first dataset such that the first dataset has a fifth set of labels comprising the first set of labels and at least one label of the third set of labels that is not in the first set of labels.

At block 450, for the condition where the fifth set of labels contains two instances of a label “x”, all but one of the instances of the label “x” are deleted from the fifth set of labels.

At block 460, for the condition where the fourth object is a subset of the first object, the first set of labels is assigned to the fourth dataset such that the fourth dataset has a sixth set of labels comprising the fourth set of labels and at least one label of the first set of labels that is not in the fourth set of labels.

At block 470, for the condition where the sixth set of labels contains two instances of a label “y”, all but one of the instances of the label “y” are deleted from the sixth set of labels.

At block 480, the first dataset having the fifth set of labels is combined with the second geospatial data to thereby generate a first enhanced geospatial database.

The above method may be embodied in a non-transitory machine-readable medium and/or be used in a computerized system for generating an enhanced geospatial database.

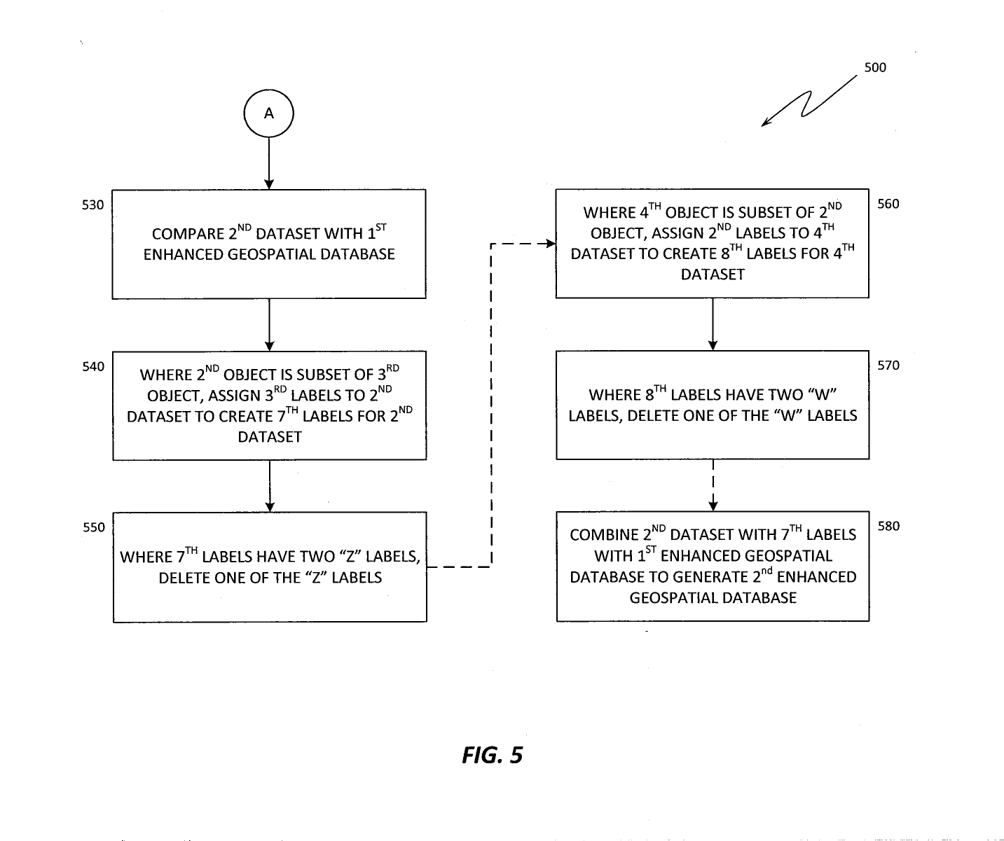

Now considering FIG. 5, a flow chart 500 is presented for further methods for generating an enhanced geospatial database according to additional embodiments of the present subject matter.

In an embodiment continuing from FIG. 4, at block 530, the second dataset is compared with the first enhanced geospatial database.

At block 540, for the condition where the second object is a subset of the third object, the third set of labels is assigned to the second dataset such that the second dataset has a seventh set of labels comprising the second set of labels and at least one label of the third set of labels that is not in the second set of labels.

At block 550, for the condition where the seventh set of labels contains two instances of a label “z”, all but one of the instances of the label “z” are deleted from the seventh set of labels.

In a further embodiment, at block 560, for the condition where the fourth object is a subset of the second object, the second set of labels is assigned to the fourth dataset such that the fourth dataset has an eighth set of labels comprising the sixth set of labels and at least one label of the second set of labels that is not in the sixth set of labels.

At block 570, for the condition where the eighth set of labels contains two instances of a label “w”, all but one of the instances of the label “w” are deleted from the eighth set of labels.

In a still further embodiment, at block 580, the second dataset having the seventh set of labels is combined with the first enhanced geospatial database to thereby generate a second enhanced geospatial database.

Any of the above methods may be embodied in a non-transitory machine-readable medium and/or be used in a computerized system for generating an enhanced geospatial database.

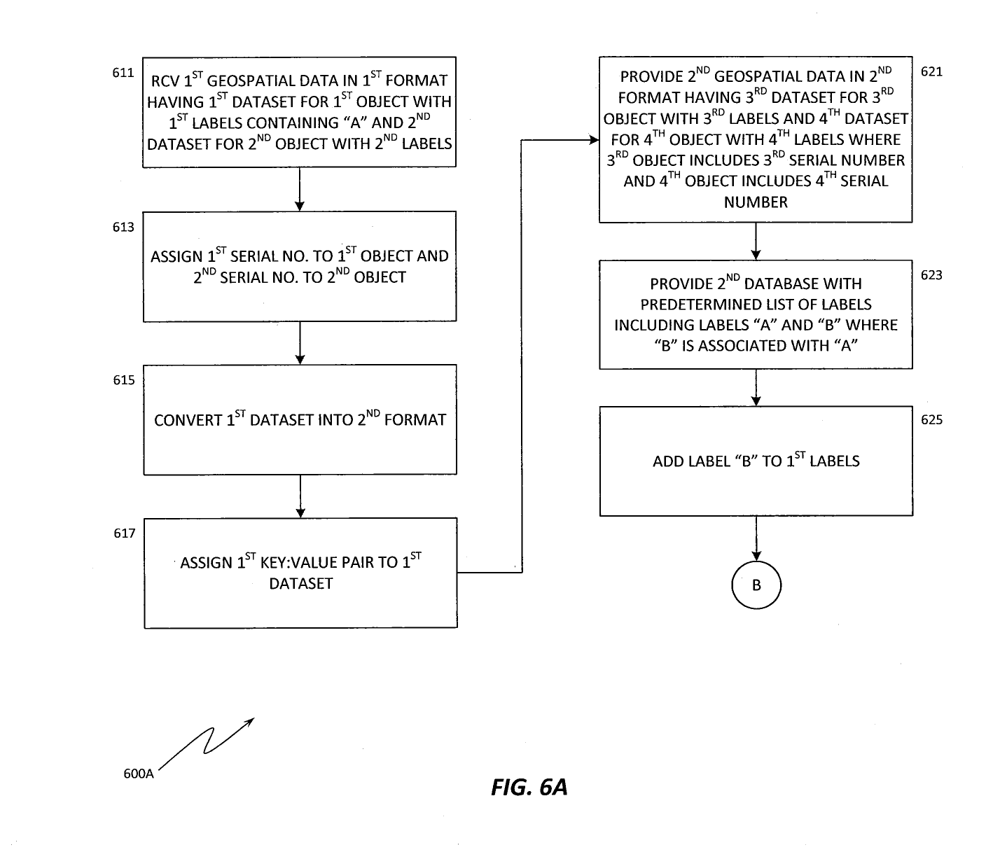

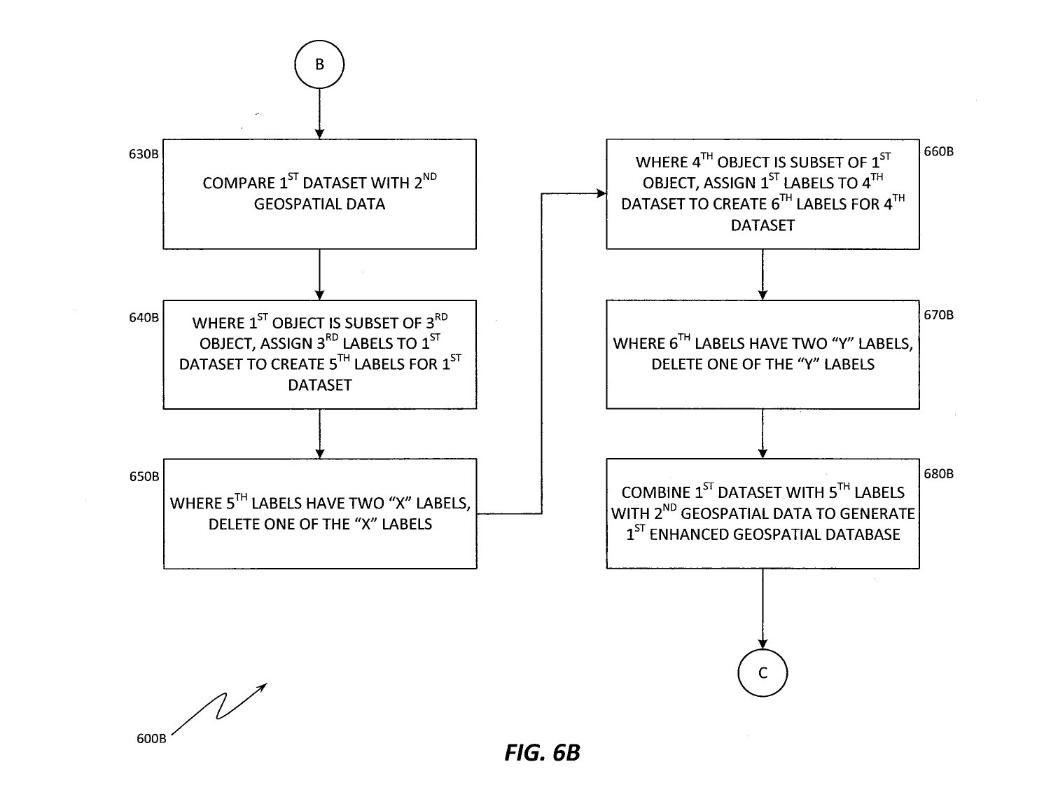

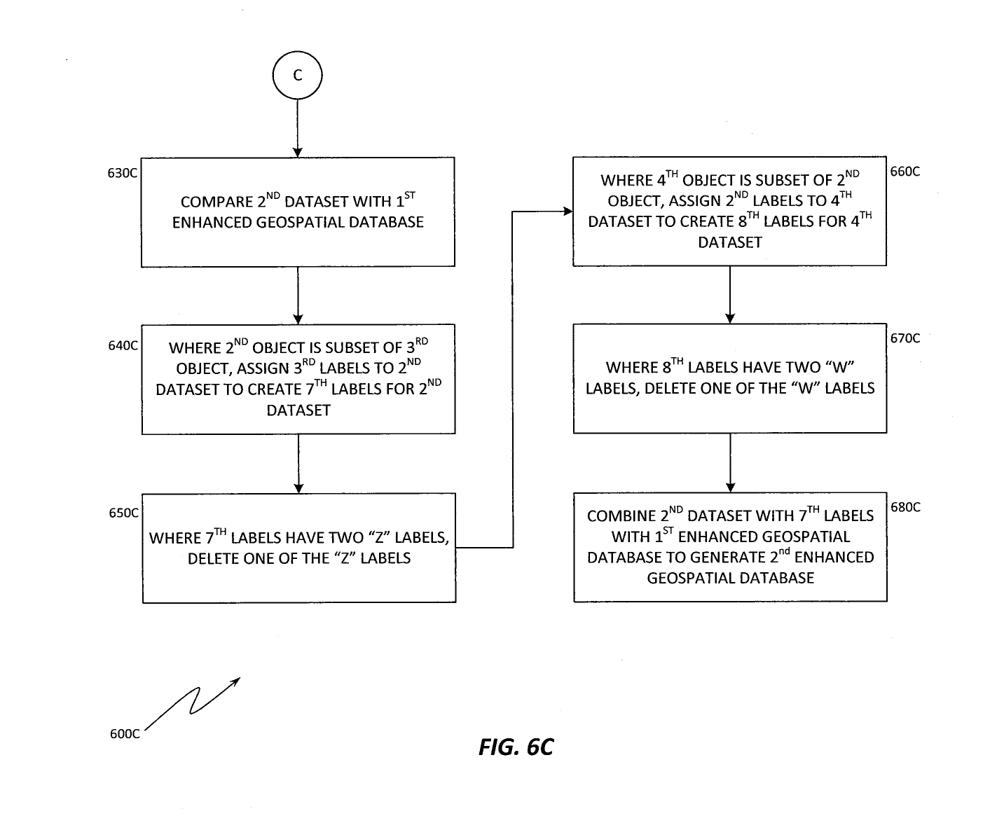

FIGS. 6A-6C represent a flow chart (660A, 600B, and 600C) for an additional method for generating an enhanced geospatial database according to another embodiment of the present subject matter.

At block 611, first geospatial data is received in a first format where the first geospatial data comprises a first dataset having a first set of labels and a second dataset having a second set of labels, and where the first dataset represents a first object and the second dataset represents a second object, and where the first set of labels includes a label “A”.

At block 613, a first serial number is assigned to the first object and a second serial number to the second object.

At block 615, the first dataset is converted into a second format.

At block 617, a first key:value pair is assigned to the first dataset.

At block 621, a database of second geospatial data is provided in the second format, where the second geospatial data comprises a third dataset having a third set of labels and a fourth dataset having a fourth set of labels, and where the third dataset represents a third object and the fourth dataset represents a fourth object, where the third object further includes a third serial number and the fourth object includes a fourth serial number.

At block 623, a second database is provided comprising a predetermined list of labels including the label “A” and a label “B”, where the label “B” is associated with the label “A”.

At block 625, the label “B” is added to the first set of labels.

At block 630B, the first dataset is compared with the second geospatial data.

At block 640B, for the condition where the first object is a subset of the third object, the third set of labels is assigned to the first dataset such that the first dataset has a fifth set of labels comprising the first set of labels and at least one label of the third set of labels that is not in the first set of labels.

At block 650B, for the condition where the fifth set of labels contains two instances of a label “x”, all but one of the instances of the label “x” are deleted from the fifth set of labels.

At block 660B, for the condition where the fourth object is a subset of the first object, the first set of labels is assigned to the fourth dataset such that the fourth dataset has a sixth set of labels comprising the fourth set of labels and at least one label of the first set of labels that is not in the fourth set of labels.

At block 670B, for the condition where the sixth set of labels contains two instances of a label “y”, all but one of the instances of the label “y” are deleted from the sixth set of labels.

At block 680B, the first dataset having the fifth set of labels is combined with the second geospatial data to thereby generate a first enhanced geospatial database.

At block 630C, the second dataset is compared with the first enhanced geospatial database.

At block 640C, for the condition where the second object is a subset of the third object, the third set of labels is assigned to the second dataset such that the second dataset has a seventh set of labels comprising the second set of labels and at least one label of the third set of labels that is not in the second set of labels.

At block 650C, for the condition where the seventh set of labels contains two instances of a label “z”, all but one of the instances of the label “z” are deleted from the seventh set of labels.

At block 660C, for the condition where the fourth object is a subset of the second object, the second set of labels is assigned to the fourth dataset such that the fourth dataset has an eighth set of labels comprising the sixth set of labels and at least one label of the second set of labels that is not in the sixth set of labels.

At block 670C, for the condition where the eighth set of labels contains two instances of a label “w”, all but one of the instances of the label “w” are deleted from the eighth set of labels.

At block 680C, the second dataset having the seventh set of labels is combined with the first enhanced geospatial database to thereby generate a second enhanced geospatial database.

The above method may be embodied in a non-transitory machine-readable medium and/or be used in a computerized system for generating an enhanced geospatial database.

Additionally, any of the methods described in FIGS. 4, 5, and/or 6A-6C may include one or more of the following: the third object includes a third serial number and the fourth object includes a fourth serial number, and the method further includes assigning a first serial number to the first object and a second serial number to the second object; the first set of labels includes a label “A” and the method further includes providing a second database comprising a predetermined list of labels including the label “A” and a label “B”, where the label “B” has a predetermined association with the label “A”, and the label “B” is added to the first set of labels; the first object is a geographic feature; the fourth object is an event; the first geospatial data is vector data; the first geospatial data is raster data; the first object is selected from the group consisting of: Polygon, MultiPolygon, LineString, MultiLineString, Point, and MultiPoint; the first object is a Polygon and at least one of the third object or the fourth object is not a Polygon; and the first object is an event and at least one of the third object or the fourth object is a geographic feature.

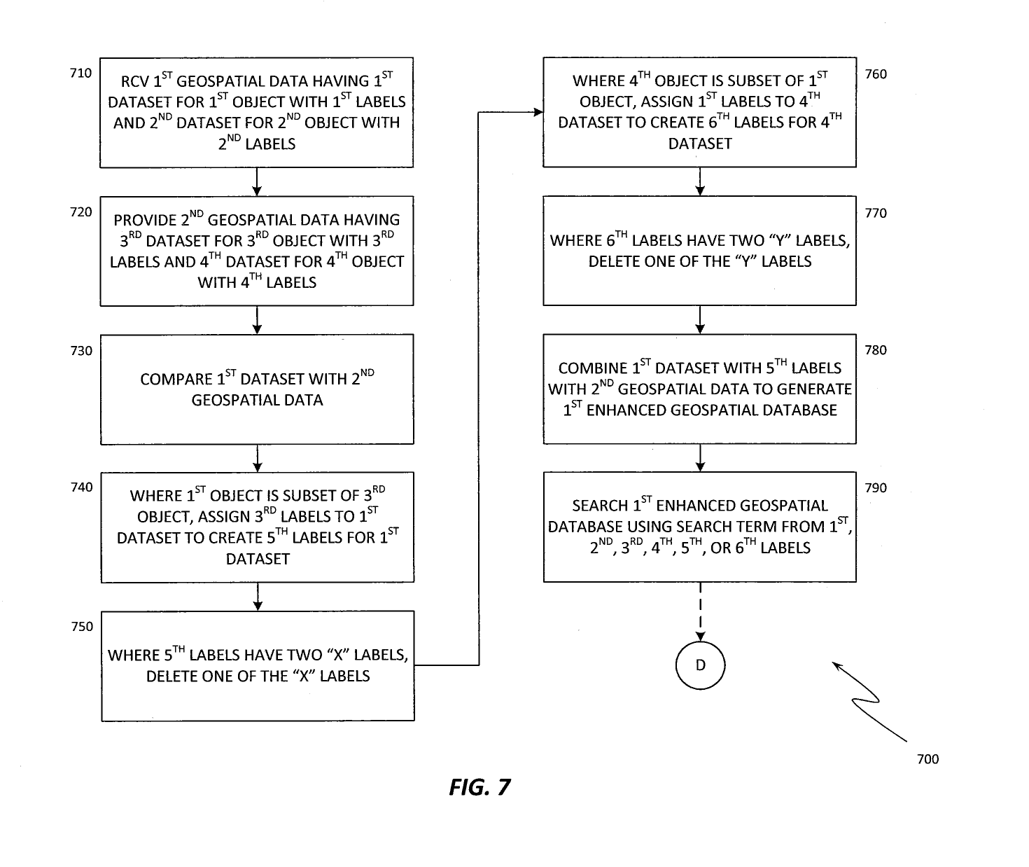

FIG. 7 depicts a flow chart 700 for a method for searching an enhanced geospatial database according to an embodiment of the present subject matter.

At block 710, first geospatial data is received where the first geospatial data comprises a first dataset having a first set of labels and a second dataset having a second set of labels, and where the first dataset represents a first object and the second dataset represents a second object.

At block 720, a database of second geospatial data is provided where the second geospatial data comprises a third dataset having a third set of labels and a fourth dataset having a fourth set of labels, and where the third dataset represents a third object and the fourth dataset represents a fourth object.

At block 730, the first dataset is compared with the second geospatial data.

At block 740, for the condition where the first object is a subset of the third object, the third set of labels is assigned to the first dataset such that the first dataset has a fifth set of labels comprising the first set of labels and at least one label of the third set of labels that is not in the first set of labels.

At block 750, for the condition where the fifth set of labels contains two instances of a label “x”, all but one of the instances of the label “x” are deleted from the fifth set of labels.

At block 760, for the condition where the fourth object is a subset of the first object, the first set of labels is assigned to the fourth dataset such that the fourth dataset has a sixth set of labels comprising the fourth set of labels and at least one label of the first set of labels that is not in the fourth set of labels.

At block 770, for the condition where the sixth set of labels contains two instances of a label “y”, all but one of the instances of the label “y” are deleted from the sixth set of labels.

At block 780, the first dataset having the fifth set of labels is combined with the second geospatial data to thereby generate a first enhanced geospatial database.

At block 790, the first enhanced geospatial database is searched with a search term where the search term is a label from any of the first, second, third, fourth, fifth, or sixth set of labels.

The above method may be embodied in a non-transitory machine-readable medium and/or be used in a computerized system for generating an enhanced geospatial database.

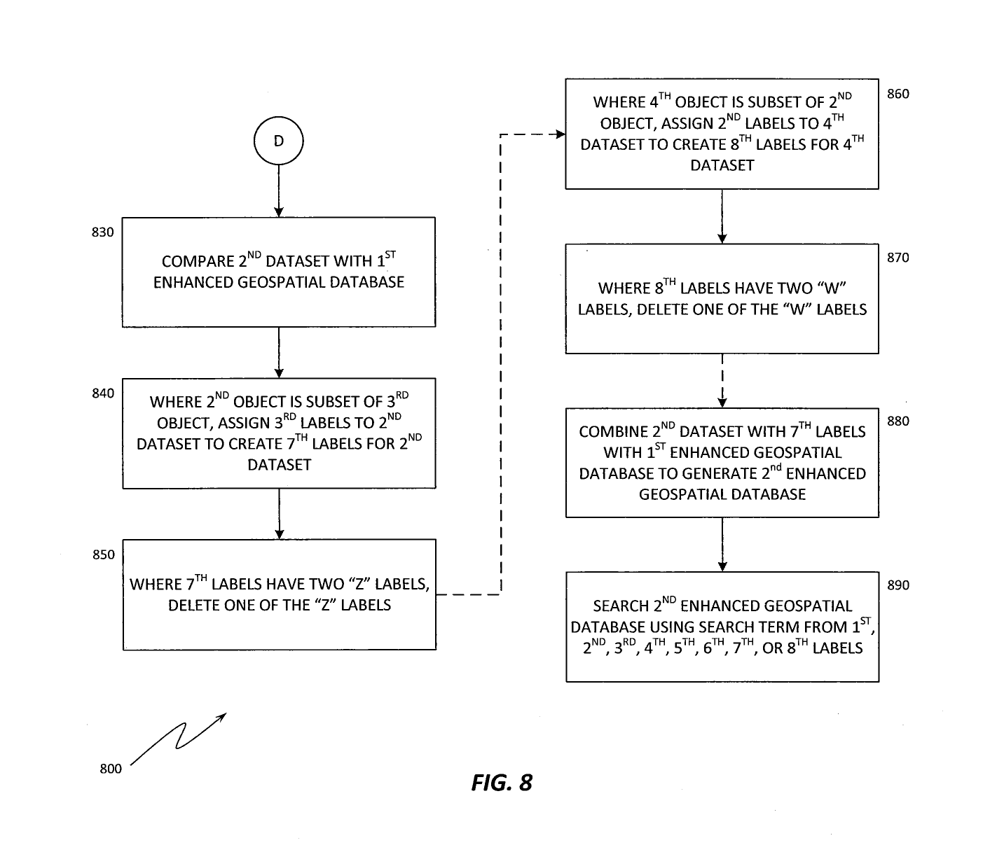

With attention now drawn to FIG. 8, a flow chart 800 is presented for further methods for searching an enhanced geospatial database according to additional embodiments of the present subject matter.

In an embodiment continuing from FIG. 7, at block 830, the second dataset is compared with the first enhanced geospatial database.

At block 840, for the condition where the second object is a subset of the third object, the third set of labels is assigned to the second dataset such that the second dataset has a seventh set of labels comprising the second set of labels and at least one label of the third set of labels that is not in the second set of labels.

At block 850, for the condition where the seventh set of labels contains two instances of a label “z”, all but one of the instances of the label “z” are deleted from the seventh set of labels.

In a further embodiment, at block 860, for the condition where the fourth object is a subset of the second object, the second set of labels is assigned to the fourth dataset such that the fourth dataset has an eighth set of labels comprising the sixth set of labels and at least one label of the second set of labels that is not in the sixth set of labels.

At block 870, for the condition where the eighth set of labels contains two instances of a label “w”, all but one of the instances of the label “w” are deleted from the eighth set of labels.

In a still further embodiment, at block 880, the second dataset having the seventh set of labels is combined with the first enhanced geospatial database to thereby generate a second enhanced geospatial database.

At block 890, the second enhanced geospatial database is searched with a search term where the search term is a label from any of the first, second, third, fourth, fifth, sixth, seventh, or eighth set of labels.

Any of the above methods may be embodied in a non-transitory machine-readable medium and/or be used in a computerized system for generating an enhanced geospatial database.

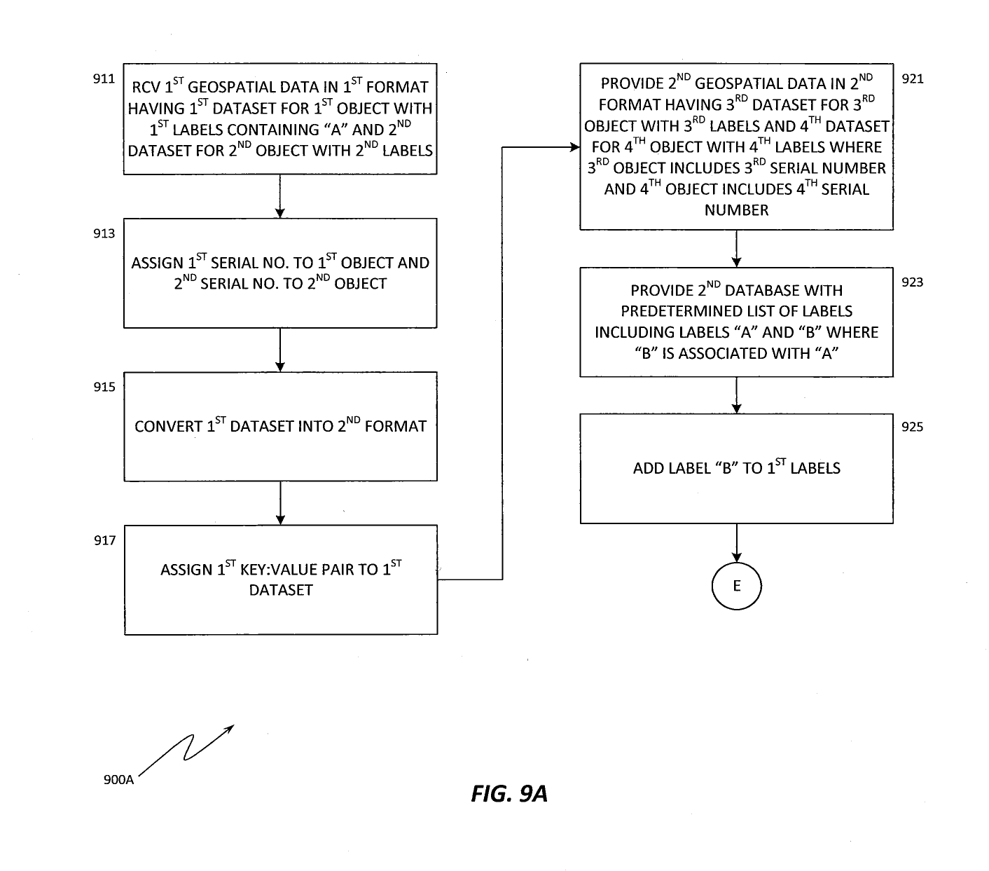

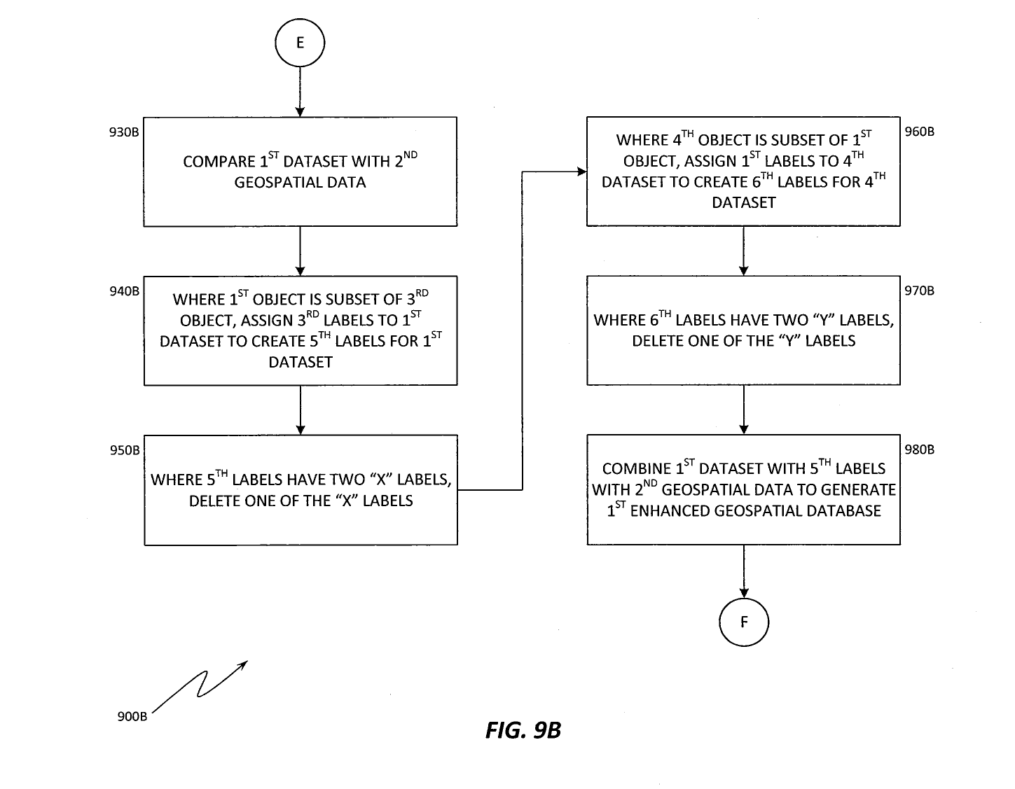

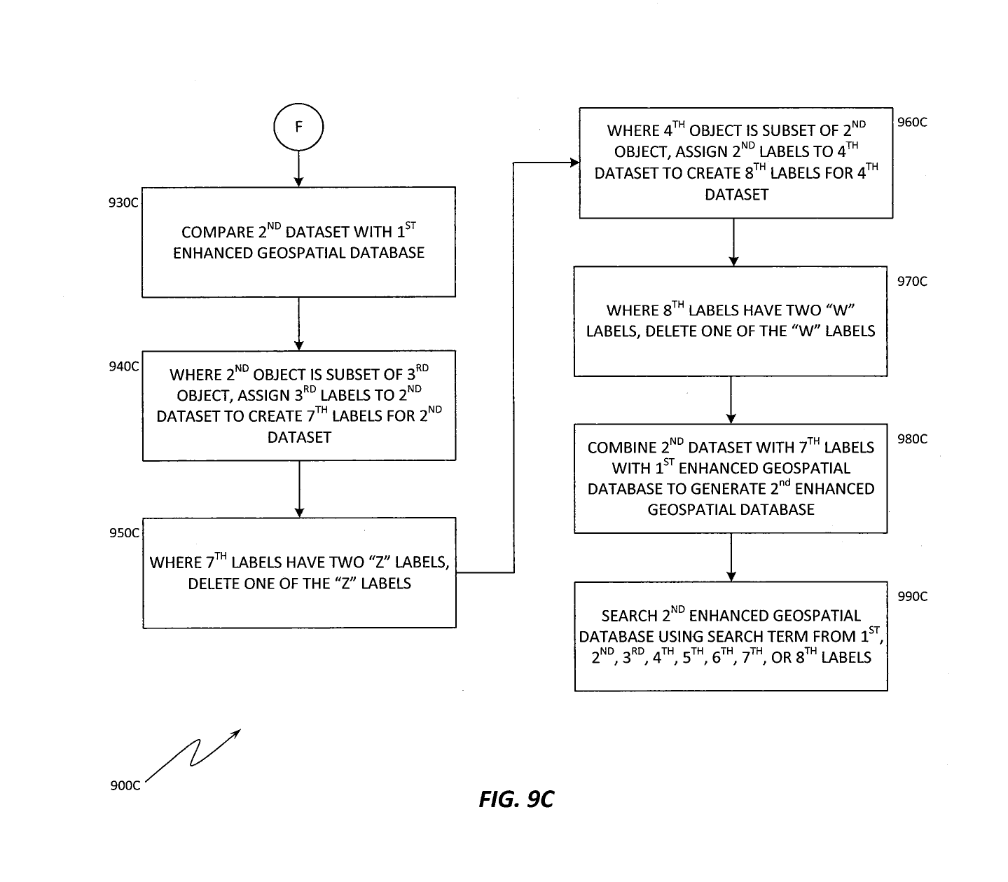

FIGS. 9A-9C represent a flow chart (900A, 900B, and 900C) for an additional method for searching an enhanced geospatial database according to another embodiment of the present subject matter.

At block 911, first geospatial data is received in a first format where the first geospatial data comprises a first dataset having a first set of labels and a second dataset having a second set of labels, and where the first dataset represents a first object and the second dataset represents a second object, and where the first set of labels includes a label “A”.

At block 913, a first serial number is assigned to the first object and a second serial number to the second object.

At block 915, the first dataset is converted into a second format.

At block 917, a first key:value pair is assigned to the first dataset.

At block 921, a database of second geospatial data is provided in the second format, where the second geospatial data comprises a third dataset having a third set of labels and a fourth dataset having a fourth set of labels, and where the third dataset represents a third object and the fourth dataset represents a fourth object, where the third object further includes a third serial number and the fourth object includes a fourth serial number.

At block 923, a second database is provided comprising a predetermined list of labels including the label “A” and a label “B”, where the label “B” is associated with the label “A”.

At block 925, the label “B” is added to the first set of labels.

At block 930B, the first dataset is compared with the second geospatial data.

At block 940B, for the condition where the first object is a subset of the third object, the third set of labels is assigned to the first dataset such that the first dataset has a fifth set of labels comprising the first set of labels and at least one label of the third set of labels that is not in the first set of labels.

At block 950B, for the condition where the fifth set of labels contains two instances of a label “x”, all but one of the instances of the label “x” are deleted from the fifth set of labels.

At block 960B, for the condition where the fourth object is a subset of the first object, the first set of labels is assigned to the fourth dataset such that the fourth dataset has a sixth set of labels comprising the fourth set of labels and at least one label of the first set of labels that is not in the fourth set of labels.

At block 970B, for the condition where the sixth set of labels contains two instances of a label “y”, all but one of the instances of the label “y” are deleted from the sixth set of labels.

At block 980B, the first dataset having the fifth set of labels is combined with the second geospatial data to thereby generate a first enhanced geospatial database.

At block 930C, the second dataset is compared with the first enhanced geospatial database.

At block 940C, for the condition where the second object is a subset of the third object, the third set of labels is assigned to the second dataset such that the second dataset has a seventh set of labels comprising the second set of labels and at least one label of the third set of labels that is not in the second set of labels.

At block 950C, for the condition where the seventh set of labels contains two instances of a label “z”, all but one of the instances of the label “z” are deleted from the seventh set of labels.

At block 960C, for the condition where the fourth object is a subset of the second object, the second set of labels is assigned to the fourth dataset such that the fourth dataset has an eighth set of labels comprising the sixth set of labels and at least one label of the second set of labels that is not in the sixth set of labels.

At block 970C, for the condition where the eighth set of labels contains two instances of a label “w”, all but one of the instances of the label “w” are deleted from the eighth set of labels.

At block 980C, the second dataset having the seventh set of labels is combined with the first enhanced geospatial database to thereby generate a second enhanced geospatial database.

At block 990C, the second enhanced geospatial database is searched with a search term where the search term is a label from any of the first, second, third, fourth, fifth, sixth, seventh, or eighth set of labels.

The above method may be embodied in a non-transitory machine-readable medium and/or be used in a computerized system for generating an enhanced geospatial database.

Additionally, any of the methods described in FIGS. 7, 8, and/or 9A-9C may include one or more of the following: the third object includes a third serial number and the fourth object includes a fourth serial number, and the method further includes assigning a first serial number to the first object and a second serial number to the second object; the first set of labels includes a label “A” and the method further includes providing a second database comprising a predetermined list of labels including the label “A” and a label “B”, where the label “B” has a predetermined association with the label “A” and the label “B” is added to the first set of labels; the first object is a geographic feature; the fourth object is an event; the first geospatial data is vector data; the first geospatial data is raster data; the first object is selected from the group consisting of: Polygon, MultiPolygon, LineString, MultiLineString, Point, and MultiPoint; the first object is a Polygon and at least one of the third object or the fourth object is not a Polygon; and the first object is an event and at least one of the third object or the fourth object is a geographic feature.

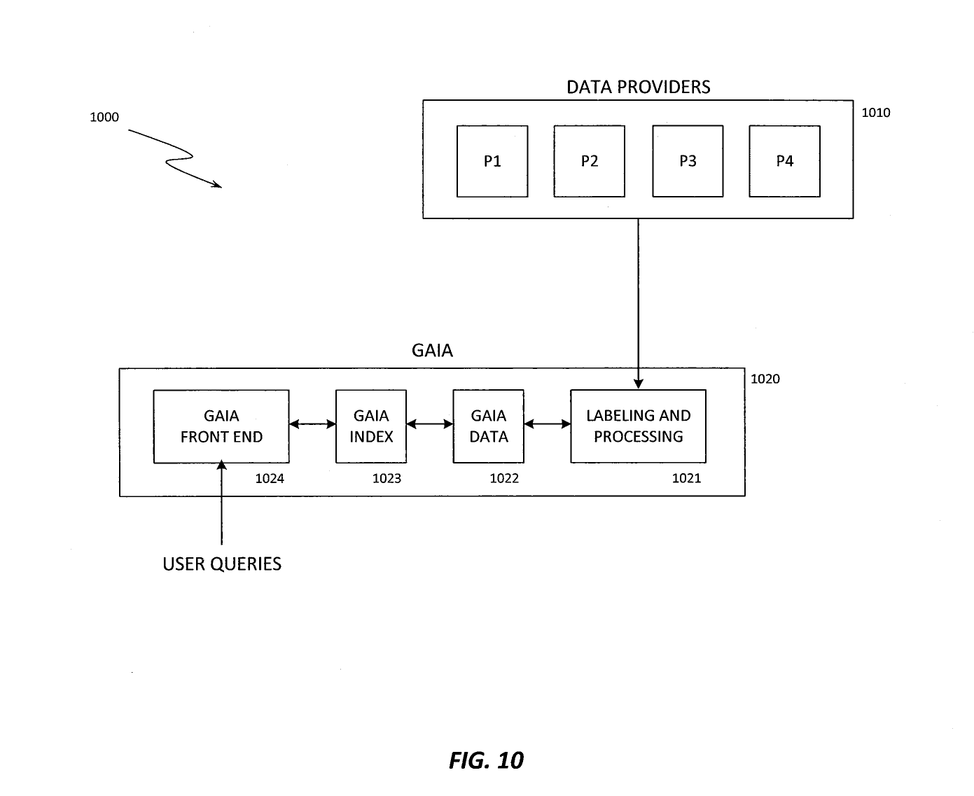

FIG. 10 is a functional block diagram 1000 for a system for generating and/or searching an enhanced geospatial database according to an embodiment of the present subject matter. Block 1010 represents data providers P1, P2, P3, and P4, any one of which, or any combination of which, may provide data to a Gaia system 1020 (as described above), such as, but not limited to, geospatial data in particular format which includes one or more datasets for one or more associated objects and further includes one or more associated sets of labels. One or more of the data providers may be a local database associated with the Gaia system 1020. Alternatively, or additionally, one or more of the data providers P1, P2, P3, and P4 may provide to the Gaia system 1020 a database with a predetermined list of labels or sets of labels.

The Gaia system 1020 typically includes a labeling and processing module 1021, which includes a processor, for labeling and processing the data received from the data providers. The output of the labeling and processing module 1021 may be stored in the Gaia data module 1022. As discussed above, in an embodiment, every time a dataset is imported the Gaia system 1020 generates a GeoJSON objects for the imported data within the basic database that describes the object in terms of spatial reference, attributes, relationships, etc. All of the generated metadata is expressed as well-known-text tags (which may be plain language text) and key value pairs. The generation of rich tags, key value pairs, and other metadata describing relationships and spatial reference creates, in an embodiment, a pseudo-hierarchy, and this generation function may set up to be completely automated, semi-autonomous, and/or user-input driven.

Furthermore, the Gaia index module 1023 interfaces between the Gaia data module 1022 and the Gaia front end module 1024 (which may be a network interface, graphic user interface, or other interface between a user and the Gaia system 1020). As shown, the Gaia front end module 1024 may receive queries (which may be unstructured) from users of the Gaia system. As discussed above, in an embodiment, the Gaia system may implement an elasticsearch algorithm that indexes all of the information and/or metadata. The elasticsearch algorithm indexes all object tags, labels, and key value pairs. The elasticsearch algorithm enables spatially fuzzy, unstructured queries for searching the database. Thus, users of the Gaia database can initiate queries using plain language and the Gaia database system will return the requested data. The Gaia system 1020 will also manage subscriptions and can offer data visualization. Due to the unique format and architecture of the Gaia system 1020, no matter how big the database gets, the query results will always be returned in an extremely fact, accurate, and relevant manner.

In an embodiment, a system for generating an enhanced geospatial database includes:

means for receiving first geospatial data in a first format where the first geospatial data comprises a first dataset having a first set of labels and a second dataset having a second set of labels, and where the first dataset represents a first object and the second dataset represents a second object, and where the first set of labels includes a label “A”;

means for assigning a first serial number to the first object and a second serial number to the second object;

a microprocessor for converting the first dataset into a second format;

the microprocessor for assigning a first key:value pair to the first dataset;

a database of second geospatial data in the second format, where the second geospatial data comprises a third dataset having a third set of labels and a fourth dataset having a fourth set of labels, and where the third dataset represents a third object and the fourth dataset represents a fourth object, where the third object further includes a third serial number and the fourth object includes a fourth serial number;

a second database comprising a predetermined list of labels including the label “A” and a label “B”, where the label “B” is associated with the label “A”;

the microprocessor for adding the label “B” to the first set of labels;

the microprocessor for comparing the first dataset with the second geospatial data;

for the condition where the first object is a subset of the third object, the microprocessor for assigning the third set of labels to the first dataset such that the first dataset has a fifth set of labels comprising the first set of labels and at least one label of the third set of labels that is not in the first set of labels;

for the condition where the fifth set of labels contains two instances of a label “x”, the microprocessor for deleting all but one of the instances of the label “x” from the fifth set of labels;

for the condition where the fourth object is a subset of the first object, the microprocessor for assigning the first set of labels to the fourth dataset such that the fourth dataset has a sixth set of labels comprising the fourth set of labels and at least one label of the first set of labels that is not in the fourth set of labels;

for the condition where the sixth set of labels contains two instances of a label “y”, the microprocessor for deleting all but one of the instances of the label “y” from the sixth set of labels;

the microprocessor for combining the first dataset having the fifth set of labels with the second geospatial data to thereby generate a first enhanced geospatial database;

the microprocessor for comparing the second dataset with the first enhanced geospatial database;

for the condition where the second object is a subset of the third object, the microprocessor for assigning the third set of labels to the second dataset such that the second dataset has a seventh set of labels comprising the second set of labels and at least one label of the third set of labels that is not in the second set of labels;

for the condition where the seventh set of labels contains two instances of a label “z”, the microprocessor for deleting all but one of the instances of the label “z” from the seventh set of labels;

for the condition where the fourth object is a subset of the second object, the microprocessor for assigning the second set of labels to the fourth dataset such that the fourth dataset has an eighth set of labels comprising the sixth set of labels and at least one label of the second set of labels that is not in the sixth set of labels;

for the condition where the eighth set of labels contains two instances of a label “w”, the microprocessor for deleting all but one of the instances of the label “w” from the eighth set of labels; and

the microprocessor for combining the second dataset having the seventh set of labels with the first enhanced geospatial database to thereby generate a second enhanced geospatial database.

In another embodiment, a system for generating an enhanced geospatial database, the system comprising:

means for receiving first geospatial data in a first format where the first geospatial data comprises a first dataset having a first set of labels and a second dataset having a second set of labels, and where the first dataset represents a first object and the second dataset represents a second object, and where the first set of labels includes a label “A”;

a microprocessor for assigning a first serial number to the first object and a second serial number to the second object;

the microprocessor for converting the first dataset into a second format;

the microprocessor for assigning a first key:value pair to the first dataset;

a database of second geospatial data in the second format, where the second geospatial data comprises a third dataset having a third set of labels and a fourth dataset having a fourth set of labels, and where the third dataset represents a third object and the fourth dataset represents a fourth object, where the third object further includes a third serial number and the fourth object includes a fourth serial number;

a second database comprising a predetermined list of labels including the label “A” and a label “B”, where the label “B” is associated with the label “A”;

the microprocessor for adding the label “B” to the first set of labels;

the microprocessor for comparing the first dataset with the second geospatial data;

for the condition where the first object is a subset of the third object, the microprocessor for assigning the third set of labels to the first dataset such that the first dataset has a fifth set of labels comprising the first set of labels and at least one label of the third set of labels that is not in the first set of labels;

for the condition where the fifth set of labels contains two instances of a label “x”, the microprocessor for deleting all but one of the instances of the label “x” from the fifth set of labels;

for the condition where the fourth object is a subset of the first object, the microprocessor for assigning the first set of labels to the fourth dataset such that the fourth dataset has a sixth set of labels comprising the fourth set of labels and at least one label of the first set of labels that is not in the fourth set of labels;

for the condition where the sixth set of labels contains two instances of a label “y”, the microprocessor for deleting all but one of the instances of the label “y” from the sixth set of labels;

the microprocessor for combining the first dataset having the fifth set of labels with the second geospatial data to thereby generate a first enhanced geospatial database;

the microprocessor for comparing the second dataset with the first enhanced geospatial database;

for the condition where the second object is a subset of the third object, the microprocessor for assigning the third set of labels to the second dataset such that the second dataset has a seventh set of labels comprising the second set of labels and at least one label of the third set of labels that is not in the second set of labels;

for the condition where the seventh set of labels contains two instances of a label “z”, the microprocessor for deleting all but one of the instances of the label “z” from the seventh set of labels;

for the condition where the fourth object is a subset of the second object, the microprocessor for assigning the second set of labels to the fourth dataset such that the fourth dataset has an eighth set of labels comprising the sixth set of labels and at least one label of the second set of labels that is not in the sixth set of labels;

for the condition where the eighth set of labels contains two instances of a label “w”, the microprocessor for deleting all but one of the instances of the label “w” from the eighth set of labels;

the microprocessor for combining the second dataset having the seventh set of labels with the first enhanced geospatial database to thereby generate a second enhanced geospatial database; and

the microprocessor for searching the second enhanced geospatial database with a search term where the search term is a label from any of the first, second, third, fourth, fifth, sixth, seventh, or eighth set of labels.

Certain embodiments of the present disclosure may be implemented by a computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and protected by the following claims.

Some embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Computer readable media suitable for storing computer program instructions and data include all forms data memory including non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the claimed subject matter, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations should always be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While some embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

We claim:

1. A method for generating an enhanced geospatial database, the method comprising the steps of:
(a) receiving first geospatial data wherein the first geospatial data comprises a first dataset having a first set of labels and a second dataset having a second set of labels, and wherein the first dataset represents a first object and the second dataset represents a second object;
(b) providing a database of second geospatial data wherein the second geospatial data comprises a third dataset having a third set of labels and a fourth dataset having a fourth set of labels, and wherein the third dataset represents a third object and the fourth dataset represents a fourth object;
(c) comparing the first dataset with the second geospatial data;
(d) for the condition where the first object is a subset of the third object, assigning the third set of labels to the first dataset such that the first dataset has a fifth set of labels comprising the first set of labels and at least one label of the third set of labels that is not in the first set of labels;
(e) for the condition where the fifth set of labels contains two instances of a label “x”, deleting all but one of the instances of the label “x” from the fifth set of labels;
(f) for the condition where the fourth object is a subset of the first object, assigning the first set of labels to the fourth dataset such that the fourth dataset has a sixth set of labels comprising the fourth set of labels and at least one label of the first set of labels that is not in the fourth set of labels;
(g) for the condition where the sixth set of labels contains two instances of a label “y”, deleting all but one of the instances of the label “y” from the sixth set of labels; and
(h) combining the first dataset having the fifth set of labels with the second geospatial data to thereby generate a first enhanced geospatial database.

2. The method of claim 1 further comprising the steps of:
(i) comparing the second dataset with the first enhanced geospatial database;
(j) for the condition where the second object is a subset of the third object, assigning the third set of labels to the second dataset such that the second dataset has a seventh set of labels comprising the second set of labels and at least one label of the third set of labels that is not in the second set of labels; and
(k) for the condition where the seventh set of labels contains two instances of a label “z”, deleting all but one of the instances of the label “z” from the seventh set of labels.

3. The method of claim 2 further comprising the steps of:
(l) for the condition where the fourth object is a subset of the second object, assigning the second set of labels to the fourth dataset such that the fourth dataset has an eighth set of labels comprising the sixth set of labels and at least one label of the second set of labels that is not in the sixth set of labels; and
(m) for the condition where the eighth set of labels contains two instances of a label “w”, deleting all but one of the instances of the label “w” from the eighth set of labels.

4. The method of claim 3 further comprising the step of:
(n) combining the second dataset having the seventh set of labels with the first enhanced geospatial database to thereby generate a second enhanced geospatial database.

5. The method of claim 1 wherein the third object includes a third serial number and the fourth object includes a fourth serial number, the method further comprising the step of:
(i) assigning a first serial number to the first object and a second serial number to the second object.

6. The method of claim 1 wherein the first set of labels includes a label “A”, the method further comprising the steps of:
(i) providing a second database comprising a predetermined list of labels including the label “A” and a label “B”, wherein the label “B” has a predetermined association with the label “A”; and
(j) adding the label “B” to the first set of labels.

7. The method of claim 1 wherein the first object is a geographic feature.

8. The method of claim 1 wherein the fourth object is an event.

9. The method of claim 1 wherein the first geospatial data is vector data.

10. The method of claim 1 wherein the first geospatial data is raster data.

11. The method of claim 1 wherein the first object is selected from the group consisting of: Polygon, MultiPolygon, LineString, MultiLineString, Point, and MultiPoint.

12. The method of claim 1 wherein the first object is a Polygon and at least one of the third object or the fourth object is not a Polygon.

13. The method of claim 1 wherein the first object is an event and at least one of the third object or the fourth object is a geographic feature.

14. A method for generating an enhanced geospatial database, the method comprising the steps of:
(a) receiving first geospatial data in a first format wherein the first geospatial data comprises a first dataset having a first set of labels and a second dataset having a second set of labels, and wherein the first dataset represents a first object and the second dataset represents a second object, and wherein the first set of labels includes a label “A”;
(b) assigning a first serial number to the first object and a second serial number to the second object;
(c) converting the first dataset into a second format;
(d) assigning a first key:value pair to the first dataset;
(e) providing a database of second geospatial data in the second format, wherein the second geospatial data comprises a third dataset having a third set of labels and a fourth dataset having a fourth set of labels, and wherein the third dataset represents a third object and the fourth dataset represents a fourth object, wherein the third object further includes a third serial number and the fourth object includes a fourth serial number;
(f) providing a second database comprising a predetermined list of labels including the label “A” and a label “B”, wherein the label “B” is associated with the label “A”;
(g) adding the label “B” to the first set of labels;
(h) comparing the first dataset with the second geospatial data;
(i) for the condition where the first object is a subset of the third object, assigning the third set of labels to the first dataset such that the first dataset has a fifth set of labels comprising the first set of labels and at least one label of the third set of labels that is not in the first set of labels;
(j) for the condition where the fifth set of labels contains two instances of a label “x”, deleting all but one of the instances of the label “x” from the fifth set of labels;
(k) for the condition where the fourth object is a subset of the first object, assigning the first set of labels to the fourth dataset such that the fourth dataset has a sixth set of labels comprising the fourth set of labels and at least one label of the first set of labels that is not in the fourth set of labels;
(l) for the condition where the sixth set of labels contains two instances of a label “y”, deleting all but one of the instances of the label “y” from the sixth set of labels;
(m) combining the first dataset having the fifth set of labels with the second geospatial data to thereby generate a first enhanced geospatial database;
(n) comparing the second dataset with the first enhanced geospatial database;
(o) for the condition where the second object is a subset of the third object, assigning the third set of labels to the second dataset such that the second dataset has a seventh set of labels comprising the second set of labels and at least one label of the third set of labels that is not in the second set of labels;
(p) for the condition where the seventh set of labels contains two instances of a label “z”, deleting all but one of the instances of the label “z” from the seventh set of labels;
(q) for the condition where the fourth object is a subset of the second object, assigning the second set of labels to the fourth dataset such that the fourth dataset has an eighth set of labels comprising the sixth set of labels and at least one label of the second set of labels that is not in the sixth set of labels;
(r) for the condition where the eighth set of labels contains two instances of a label “w”, deleting all but one of the instances of the label “w” from the eighth set of labels; and
(s) combining the second dataset having the seventh set of labels with the first enhanced geospatial database to thereby generate a second enhanced geospatial database.

15. A non-transitory machine-readable medium having stored thereon a plurality of executable instructions, the plurality of instructions comprising instructions to:
(a) receive first geospatial data in a first format wherein the first geospatial data comprises a first dataset having a first set of labels and a second dataset having a second set of labels, and wherein the first dataset represents a first object and the second dataset represents a second object, and wherein the first set of labels includes a label “A”;
(b) assign a first serial number to the first object and a second serial number to the second object;
(c) convert the first dataset into a second format;
(d) assign a first key:value pair to the first dataset;
(e) provide a database of second geospatial data in the second format, wherein the second geospatial data comprises a third dataset having a third set of labels and a fourth dataset having a fourth set of labels, and wherein the third dataset represents a third object and the fourth dataset represents a fourth object, wherein the third object further includes a third serial number and the fourth object includes a fourth serial number;
(f) provide a second database comprising a predetermined list of labels including the label “A” and a label “B”, wherein the label “B” is associated with the label “A”;
(g) add the label “B” to the first set of labels;
(h) compare the first dataset with the second geospatial data;
(i) for the condition where the first object is a subset of the third object, assign the third set of labels to the first dataset such that the first dataset has a fifth set of labels comprising the first set of labels and at least one label of the third set of labels that is not in the first set of labels;
(j) for the condition where the fifth set of labels contains two instances of a label “x”, delete all but one of the instances of the label “x” from the fifth set of labels;
(k) for the condition where the fourth object is a subset of the first object, assign the first set of labels to the fourth dataset such that the fourth dataset has a sixth set of labels comprising the fourth set of labels and at least one label of the first set of labels that is not in the fourth set of labels;
(l) for the condition where the sixth set of labels contains two instances of a label “y”, delete all but one of the instances of the label “y” from the sixth set of labels;
(m) combine the first dataset having the fifth set of labels with the second geospatial data to thereby generate a first enhanced geospatial database;
(n) compare the second dataset with the first enhanced geospatial database;
(o) for the condition where the second object is a subset of the third object, assign the third set of labels to the second dataset such that the second dataset has a seventh set of labels comprising the second set of labels and at least one label of the third set of labels that is not in the second set of labels;
(p) for the condition where the seventh set of labels contains two instances of a label “z”, delete all but one of the instances of the label “z” from the seventh set of labels;
(q) for the condition where the fourth object is a subset of the second object, assign the second set of labels to the fourth dataset such that the fourth dataset has an eighth set of labels comprising the sixth set of labels and at least one label of the second set of labels that is not in the sixth set of labels;
(r) for the condition where the eighth set of labels contains two instances of a label “w”, delete all but one of the instances of the label “w” from the eighth set of labels; and
(s) combine the second dataset having the seventh set of labels with the first enhanced geospatial database to thereby generate a second enhanced geospatial database.

16. A method for searching an enhanced geospatial database, the method comprising the steps of:
(a) receiving first geospatial data wherein the first geospatial data comprises a first dataset having a first set of labels and a second dataset having a second set of labels, and wherein the first dataset represents a first object and the second dataset represents a second object;
(b) providing a database of second geospatial data wherein the second geospatial data comprises a third dataset having a third set of labels and a fourth dataset having a fourth set of labels, and wherein the third dataset represents a third object and the fourth dataset represents a fourth object;
(c) comparing the first dataset with the second geospatial data;
(d) for the condition where the first object is a subset of the third object, assigning the third set of labels to the first dataset such that the first dataset has a fifth set of labels comprising the first set of labels and at least one label of the third set of labels that is not in the first set of labels;
(e) for the condition where the fifth set of labels contains two instances of a label “x”, deleting all but one of the instances of the label “x” from the fifth set of labels;
(f) for the condition where the fourth object is a subset of the first object, assigning the first set of labels to the fourth dataset such that the fourth dataset has a sixth set of labels comprising the fourth set of labels and at least one label of the first set of labels that is not in the fourth set of labels;
(g) for the condition where the sixth set of labels contains two instances of a label “y”, deleting all but one of the instances of the label “y” from the sixth set of labels;
(h) combining the first dataset having the fifth set of labels with the second geospatial data to thereby generate a first enhanced geospatial database; and
(i) searching the first enhanced geospatial database with a search term wherein the search term is a label from any of the first, second, third, fourth, fifth, or sixth set of labels.

17. The method of claim 16 further comprising the steps of:
(j) comparing the second dataset with the first enhanced geospatial database;
(k) for the condition where the second object is a subset of the third object, assigning the third set of labels to the second dataset such that the second dataset has a seventh set of labels comprising the second set of labels and at least one label of the third set of labels that is not in the second set of labels; and
(l) for the condition where the seventh set of labels contains two instances of a label “z”, deleting all but one of the instances of the label “z” from the seventh set of labels.

18. The method of claim 17 further comprising the steps of:
(m) for the condition where the fourth object is a subset of the second object, assigning the second set of labels to the fourth dataset such that the fourth dataset has an eighth set of labels comprising the sixth set of labels and at least one label of the second set of labels that is not in the sixth set of labels; and
(n) for the condition where the eighth set of labels contains two instances of a label “w”, deleting all but one of the instances of the label “w” from the eighth set of labels.

19. The method of claim 18 further comprising the step of:
(o) combining the second dataset having the seventh set of labels with the first enhanced geospatial database to thereby generate a second enhanced geospatial database; and
(p) searching the second enhanced geospatial database with a search term wherein the search term is a label from any of the first, second, third, fourth, fifth, sixth, seventh, or eighth set of labels.

20. The method of claim 16 wherein the third object further includes a third serial number and the fourth object includes a fourth serial number, the method further comprising the step of:
(j) assigning a first serial number to the first object and a second serial number to the second object.

21. The method of claim 16 wherein the first set of labels includes a label “A”, the method further comprising the steps of:
(j) providing a second database comprising a predetermined list of labels including the label “A” and a label “B”, wherein the label “B” has a predetermined association with the label “A”; and
(k) adding the label “B” to the first set of labels.

22. The method of claim 16 wherein the first object is a geographic feature.

23. The method of claim 16 wherein the fourth object is an event.

24. The method of claim 16 wherein the first geospatial data is vector data.

25. The method of claim 16 wherein the first geospatial data is raster data.

26. The method of claim 16 wherein the first object is selected from the group consisting of: Polygon, MultiPolygon, LineString, MultiLineString, Point, and MultiPoint.

27. The method of claim 16 wherein the first object is a Polygon and at least one of the third object or the fourth object is not a Polygon.

28. The method of claim 16 wherein the first object is an event and at least one of the third object or the fourth object is a geographic feature.

29. A method for generating an enhanced geospatial database, the method comprising the steps of:
(a) receiving first geospatial data in a first format wherein the first geospatial data comprises a first dataset having a first set of labels and a second dataset having a second set of labels, and wherein the first dataset represents a first object and the second dataset represents a second object, and wherein the first set of labels includes a label “A”;
(b) assigning a first serial number to the first object and a second serial number to the second object;
(c) converting the first dataset into a second format;
(d) assigning a first key:value pair to the first dataset;
(e) providing a database of second geospatial data in the second format, wherein the second geospatial data comprises a third dataset having a third set of labels and a fourth dataset having a fourth set of labels, and wherein the third dataset represents a third object and the fourth dataset represents a fourth object, wherein the third object further includes a third serial number and the fourth object includes a fourth serial number;
(f) providing a second database comprising a predetermined list of labels including the label “A” and a label “B”, wherein the label “B” is associated with the label “A”;
(g) adding the label “B” to the first set of labels;
(h) comparing the first dataset with the second geospatial data;
(i) for the condition where the first object is a subset of the third object, assigning the third set of labels to the first dataset such that the first dataset has a fifth set of labels comprising the first set of labels and at least one label of the third set of labels that is not in the first set of labels;
(j) for the condition where the fifth set of labels contains two instances of a label “x”, deleting all but one of the instances of the label “x” from the fifth set of labels;
(k) for the condition where the fourth object is a subset of the first object, assigning the first set of labels to the fourth dataset such that the fourth dataset has a sixth set of labels comprising the fourth set of labels and at least one label of the first set of labels that is not in the fourth set of labels;
(l) for the condition where the sixth set of labels contains two instances of a label “y”, deleting all but one of the instances of the label “y” from the sixth set of labels;
(m) combining the first dataset having the fifth set of labels with the second geospatial data to thereby generate a first enhanced geospatial database;
(n) comparing the second dataset with the first enhanced geospatial database;
(o) for the condition where the second object is a subset of the third object, assigning the third set of labels to the second dataset such that the second dataset has a seventh set of labels comprising the second set of labels and at least one label of the third set of labels that is not in the second set of labels;
(p) for the condition where the seventh set of labels contains two instances of a label “z”, deleting all but one of the instances of the label “z” from the seventh set of labels;
(q) for the condition where the fourth object is a subset of the second object, assigning the second set of labels to the fourth dataset such that the fourth dataset has an eighth set of labels comprising the sixth set of labels and at least one label of the second set of labels that is not in the sixth set of labels;
(r) for the condition where the eighth set of labels contains two instances of a label “w”, deleting all but one of the instances of the label “w” from the eighth set of labels;
(s) combining the second dataset having the seventh set of labels with the first enhanced geospatial database to thereby generate a second enhanced geospatial database; and
(t) searching the second enhanced geospatial database with a search term wherein the search term is a label from any of the first, second, third, fourth, fifth, sixth, seventh, or eighth set of labels.

30. A non-transitory machine-readable medium having stored thereon a plurality of executable instructions, the plurality of instructions comprising instructions to:
(a) receive first geospatial data in a first format wherein the first geospatial data comprises a first dataset having a first set of labels and a second dataset having a second set of labels, and wherein the first dataset represents a first object and the second dataset represents a second object, and wherein the first set of labels includes a label “A”;
(b) assign a first serial number to the first object and a second serial number to the second object;
(c) convert the first dataset into a second format;
(d) assign a first key:value pair to the first dataset;
(e) provide a database of second geospatial data in the second format, wherein the second geospatial data comprises a third dataset having a third set of labels and a fourth dataset having a fourth set of labels, and wherein the third dataset represents a third object and the fourth dataset represents a fourth object, wherein the third object further includes a third serial number and the fourth object includes a fourth serial number;
(f) provide a second database comprising a predetermined list of labels including the label “A” and a label “B”, wherein the label “B” is associated with the label “A”;
(g) add the label “B” to the first set of labels;
(h) compare the first dataset with the second geospatial data;
(i) for the condition where the first object is a subset of the third object, assign the third set of labels to the first dataset such that the first dataset has a fifth set of labels comprising the first set of labels and at least one label of the third set of labels that is not in the first set of labels;
(j) for the condition where the fifth set of labels contains two instances of a label “x”, delete all but one of the instances of the label “x” from the fifth set of labels;
(k) for the condition where the fourth object is a subset of the first object, assign the first set of labels to the fourth dataset such that the fourth dataset has a sixth set of labels comprising the fourth set of labels and at least one label of the first set of labels that is not in the fourth set of labels;
(l) for the condition where the sixth set of labels contains two instances of a label “y”, delete all but one of the instances of the label “y” from the sixth set of labels;
(m) combine the first dataset having the fifth set of labels with the second geospatial data to thereby generate a first enhanced geospatial database;
(n) compare the second dataset with the first enhanced geospatial database;
(o) for the condition where the second object is a subset of the third object, assign the third set of labels to the second dataset such that the second dataset has a seventh set of labels comprising the second set of labels and at least one label of the third set of labels that is not in the second set of labels;
(p) for the condition where the seventh set of labels contains two instances of a label “z”, delete all but one of the instances of the label “z” from the seventh set of labels;
(q) for the condition where the fourth object is a subset of the second object, assign the second set of labels to the fourth dataset such that the fourth dataset has an eighth set of labels comprising the sixth set of labels and at least one label of the second set of labels that is not in the sixth set of labels;
(r) for the condition where the eighth set of labels contains two instances of a label “w”, delete all but one of the instances of the label “w” from the eighth set of labels;
(s) combine the second dataset having the seventh set of labels with the first enhanced geospatial database to thereby generate a second enhanced geospatial database; and
(t) search the second enhanced geospatial database with a search term wherein the search term is a label from any of the first, second, third, fourth, fifth, sixth, seventh, or eighth set of labels.

31. A system for generating an enhanced geospatial database, comprising:
(a) means for receiving first geospatial data in a first format wherein the first geospatial data comprises a first dataset having a first set of labels and a second dataset having a second set of labels, and wherein the first dataset represents a first object and the second dataset represents a second object, and wherein the first set of labels includes a label “A”;
(b) means for assigning a first serial number to the first object and a second serial number to the second object;
(c) a microprocessor for converting the first dataset into a second format;
(d) the microprocessor for assigning a first key:value pair to the first dataset;
(e) a database of second geospatial data in the second format, wherein the second geospatial data comprises a third dataset having a third set of labels and a fourth dataset having a fourth set of labels, and wherein the third dataset represents a third object and the fourth dataset represents a fourth object, wherein the third object further includes a third serial number and the fourth object includes a fourth serial number;
(f) a second database comprising a predetermined list of labels including the label “A” and a label “B”, wherein the label “B” is associated with the label “A”;
(g) the microprocessor for adding the label “B” to the first set of labels;
(h) the microprocessor for comparing the first dataset with the second geospatial data;
(i) for the condition where the first object is a subset of the third object, the microprocessor for assigning the third set of labels to the first dataset such that the first dataset has a fifth set of labels comprising the first set of labels and at least one label of the third set of labels that is not in the first set of labels;
(j) for the condition where the fifth set of labels contains two instances of a label “x”, the microprocessor for deleting all but one of the instances of the label “x” from the fifth set of labels;
(k) for the condition where the fourth object is a subset of the first object, the microprocessor for assigning the first set of labels to the fourth dataset such that the fourth dataset has a sixth set of labels comprising the fourth set of labels and at least one label of the first set of labels that is not in the fourth set of labels;
(l) for the condition where the sixth set of labels contains two instances of a label “y”, the microprocessor for deleting all but one of the instances of the label “y” from the sixth set of labels;
(m) the microprocessor for combining the first dataset having the fifth set of labels with the second geospatial data to thereby generate a first enhanced geospatial database;
(n) the microprocessor for comparing the second dataset with the first enhanced geospatial database;
(o) for the condition where the second object is a subset of the third object, the microprocessor for assigning the third set of labels to the second dataset such that the second dataset has a seventh set of labels comprising the second set of labels and at least one label of the third set of labels that is not in the second set of labels;
(p) for the condition where the seventh set of labels contains two instances of a label “z”, the microprocessor for deleting all but one of the instances of the label “z” from the seventh set of labels;
(q) for the condition where the fourth object is a subset of the second object, the microprocessor for assigning the second set of labels to the fourth dataset such that the fourth dataset has an eighth set of labels comprising the sixth set of labels and at least one label of the second set of labels that is not in the sixth set of labels;
(r) for the condition where the eighth set of labels contains two instances of a label “w”, the microprocessor for deleting all but one of the instances of the label “w” from the eighth set of labels; and
(s) the microprocessor for combining the second dataset having the seventh set of labels with the first enhanced geospatial database to thereby generate a second enhanced geospatial database.

32. A system for generating an enhanced geospatial database, the system comprising:
(a) means for receiving first geospatial data in a first format wherein the first geospatial data comprises a first dataset having a first set of labels and a second dataset having a second set of labels, and wherein the first dataset represents a first object and the second dataset represents a second object, and wherein the first set of labels includes a label “A”;
(b) a microprocessor for assigning a first serial number to the first object and a second serial number to the second object;
(c) the microprocessor for converting the first dataset into a second format;
(d) the microprocessor for assigning a first key:value pair to the first dataset;
(e) a database of second geospatial data in the second format, wherein the second geospatial data comprises a third dataset having a third set of labels and a fourth dataset having a fourth set of labels, and wherein the third dataset represents a third object and the fourth dataset represents a fourth object, wherein the third object further includes a third serial number and the fourth object includes a fourth serial number;
(f) a second database comprising a predetermined list of labels including the label “A” and a label “B”, wherein the label “B” is associated with the label “A”;
(g) the microprocessor for adding the label “B” to the first set of labels;
(h) the microprocessor for comparing the first dataset with the second geospatial data;
(i) for the condition where the first object is a subset of the third object, the microprocessor for assigning the third set of labels to the first dataset such that the first dataset has a fifth set of labels comprising the first set of labels and at least one label of the third set of labels that is not in the first set of labels;
(j) for the condition where the fifth set of labels contains two instances of a label “x”, the microprocessor for deleting all but one of the instances of the label “x” from the fifth set of labels;
(k) for the condition where the fourth object is a subset of the first object, the microprocessor for assigning the first set of labels to the fourth dataset such that the fourth dataset has a sixth set of labels comprising the fourth set of labels and at least one label of the first set of labels that is not in the fourth set of labels;
(l) for the condition where the sixth set of labels contains two instances of a label “y”, the microprocessor for deleting all but one of the instances of the label “y” from the sixth set of labels;
(m) the microprocessor for combining the first dataset having the fifth set of labels with the second geospatial data to thereby generate a first enhanced geospatial database;
(n) the microprocessor for comparing the second dataset with the first enhanced geospatial database;
(o) for the condition where the second object is a subset of the third object, the microprocessor for assigning the third set of labels to the second dataset such that the second dataset has a seventh set of labels comprising the second set of labels and at least one label of the third set of labels that is not in the second set of labels;
(p) for the condition where the seventh set of labels contains two instances of a label “z”, the microprocessor for deleting all but one of the instances of the label “z” from the seventh set of labels;
(q) for the condition where the fourth object is a subset of the second object, the microprocessor for assigning the second set of labels to the fourth dataset such that the fourth dataset has an eighth set of labels comprising the sixth set of labels and at least one label of the second set of labels that is not in the sixth set of labels;
(r) for the condition where the eighth set of labels contains two instances of a label “w”, the microprocessor for deleting all but one of the instances of the label “w” from the eighth set of labels;
(s) the microprocessor for combining the second dataset having the seventh set of labels with the first enhanced geospatial database to thereby generate a second enhanced geospatial database; and
(t) the microprocessor for searching the second enhanced geospatial database with a search term wherein the search term is a label from any of the first, second, third, fourth, fifth, sixth, seventh, or eighth set of labels.
